(19) United States
(12) Patent Application Publication
(10) Pub. No.: US 2023/0359788 A1
(43) Pub. Date: Nov. 9, 2023

(54) SIMULATING PHYSICAL ENVIRONMENTS USING GRAPH NEURAL NETWORKS

(71) Applicant: DeepMind Technologies Limited, London (GB)

(72) Inventors: Alvaro Sanchez, London (GB); Jonathan William Godwin, London (GB); Rex Ying, Palo Alto, CA (US); Tobias Pfaff, London (GB); Meire Fortunato, London (GB); Peter William Battaglia, London (GB)

(21) Appl. No.: 18/027,174

(22) PCT Filed: Oct. 1, 2021
(86) PCT No.: PCT/EP2021/077174

§ 371 Date: Mar. 20, 2023

Related U.S. Application Data
(60) Provisional application No. 63/086,964, filed on Oct. 2, 2020.

(51) Int. Cl. G06F 30/27

(52) U.S. Cl. CPC G06F 30/27; G06F 2113/08

(57) ABSTRACT

This specification describes a simulation system that performs simulations of physical environments using a graph neural network. At each of one or more time steps in a sequence of time steps, the system can process a representation of a current state of the physical environment at the current time step using the graph neural network to generate a prediction of a next state of the physical environment at the next time step. Some implementations of the system are adapted for hardware GLOBAL acceleration. As well as performing simulations, the system can be used to predict physical quantities based on measured real-world data. Implementations of the system are differentiable and can also be used for design optimization, and for optimal control tasks.

### CROSS-REFERENCE TO RELATED APPLICATIONS

This application claims the benefit of the filing date of U.S. Provisional Patent Application Ser. No. 63/086,964 for “SIMULATING PHYSICAL ENVIRONMENTS USING GRAPH NEURAL NETWORKS,” which was filed on Oct. 2, 2020, and which is incorporated herein by reference in its entirety.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a simulation system implemented as computer programs on one or more computers in one or more locations that performs simulations of physical environments using a graph neural network. In particular, at each of one or more time steps in a sequence of time steps, the system can process a representation of a current state of the physical environment at the current time step using the graph neural network to generate a prediction of a next state of the physical environment at the next time step.

Simulations generated by the simulation system described in this specification (e.g., that characterize predicted states of a physical environment over a sequence of time steps) can be used for any of a variety of purposes. In some cases, a visual representation of the simulation may be generated, e.g., as a video, and provided to a user of the simulation system. In some cases, a representation of the simulation may be processed to determine that a feasibility criterion is satisfied, and a physical apparatus or system may be constructed in response to the feasibility criterion being satisfied. For example, the simulation system may generate an aerodynamics simulation of airflow over an aircraft wing, and the feasibility criterion for physically constructing the aircraft wing may be that the force or stress on the aircraft wing does not exceed a threshold. In some cases, an agent (e.g., a reinforcement learning agent) interacting with a physical environment may use the simulation system to generate one or more simulations of the environment that simulate the effects of the agent performing various actions in the environment. In these cases, the agent may use the simulations of the environment as part of determining whether to perform certain actions in the environment.

Throughout this specification, an “embedding” of an entity can refer to a representation of the entity as an ordered collection of numerical values, e.g., a vector or matrix of numerical values. An embedding of an entity can be generated, e.g., as the output of a neural network that processes data characterizing the entity.

According to a first aspect, there is provided a method performed by one or more data processing apparatus for simulating a state of a physical environment, the method comprising, for each of a plurality of time steps: obtaining data defining the state of the physical environment at the current time step, wherein the data defining the state of the physical environment at the current time step comprises data defining a mesh, wherein the mesh comprises a plurality of mesh nodes and a plurality of mesh edges, wherein each mesh node is associated with respective mesh node features; generating a representation of the state of the physical environment at the current time step, the representation comprising data representing a graph comprising a plurality of nodes that are each associated with a respective current node embedding and a plurality of edges that are each associated with a respective current edge embedding, wherein each node in the graph representing the state of the physical environment at the current time step corresponds to a respective mesh node; updating the graph at each of one or more update iterations, comprising, at each update iteration: processing data defining the graph using a graph neural network to update the current node embedding of each node in the graph and the current edge embedding of each edge in the graph; after the updating, processing the respective current node embedding for each node in the graph to generate a respective dynamics feature corresponding to each node in the graph; and determining the state of the physical environment at a next time step based on: (i) the dynamics features corresponding to the nodes in the graph, and (ii) the state of the physical environment at the current time step.

In some implementations, the mesh spans the physical environment.

In some implementations, the mesh represents one or more objects in the physical environment.

In some implementations, for each of the plurality of mesh nodes, the mesh node features associated with the mesh node comprise a state of the mesh node at the current time step, wherein the state of the mesh node at the current time step comprises: positional coordinates representing a position of the mesh node in a frame of reference of the physical environment at the current time step.

In some implementations, for each of the plurality of mesh nodes, the mesh node features associated with the mesh node at the current time step further comprise one or more of: a fluid density, a fluid viscosity, a pressure, or a tension, at a position in the environment corresponding to the mesh node at the current time step.

In some implementations, for each of the plurality of mesh nodes, the mesh node features associated with the mesh node further comprise a respective state of the mesh node at each of one or more previous time steps.

In some implementations, generating the representation of the state of the physical environment at the current time step comprises generating a respective current node embedding for each node in the graph, comprising, for each node in the graph: processing an input comprising one or more of the features of the mesh node corresponding to the node in the graph using a node embedding sub-network of the graph neural network to generate the current node embedding for the node in the graph.

In some implementations, for each node in the graph, the input to the node embedding sub-network further comprises one or more global features of the physical environment. In some implementations, the global features of the physical environment comprise forces being applied to the physical environment, a gravitational constant of the physical environment, a magnetic field of the physical environment, or a combination thereof.

In some implementations, each edge in the graph connects a respective pair of nodes in the graph, wherein the graph comprises a plurality of mesh-space edges and a plurality of world-space edges, wherein generating the representation of the state of the physical environment at the current time step comprises: for each pair of mesh nodes that are connected by an edge in the mesh, determining that the corresponding pair of graph nodes are connected by a mesh-space edge in the graph; and for each pair of mesh nodes that have respective positions which are separated by less than a threshold distance in a frame of reference of the physical environment, determining that the corresponding pair of graph nodes are connected by a world-space edge in the graph.

In some implementations, generating the representation of the state of the physical environment at the current time step comprises generating a respective current edge embedding for each edge in the graph, comprising, for each mesh-space edge in the graph: processing an input comprising: respective positions of the mesh nodes corresponding to the graph nodes connected by the mesh-space edge in the graph, data characterizing a difference between the respective positions of the mesh nodes corresponding to the graph nodes connected by the mesh-space edge in the graph, or a combination thereof, using a mesh-space edge embedding sub-network of the graph neural network to generate the current edge embedding for the mesh-space edge.

In some implementations, the method further includes for each world-space edge in the graph: processing an input comprising: respective positions of the mesh nodes corresponding to the graph nodes connected by the world-space edge in the graph, data characterizing a difference between the respective positions of the mesh nodes corresponding to the graph nodes connected by the world-space edge in the graph, or a combination thereof, using a world-space edge embedding sub-network of the graph neural network to generate the current edge embedding for the world-space edge.

In some implementations, at each update iteration, processing data defining the graph using the graph neural network to update the current node embedding of each node in the graph comprises, for each node in the graph: processing an input comprising: (i) the current node embedding for the node, and (ii) the respective current edge embedding for each edge that is connected to the node, using a node updating sub-network of the graph neural network to generate an updated node embedding for the node.

In some implementations, at each update iteration, processing data defining the graph using the graph neural network to update the current edge embedding of each edge in the graph comprises, for each mesh-space edge in the graph: processing an input comprising: (i) the current edge embedding for the mesh-space edge, and (ii) the respective current node embedding for each node connected by the mesh-space edge, using an mesh-space edge updating sub-network of the graph neural network to generate an updated edge embedding for the mesh-space edge.

In some implementations, at each update iteration, processing data defining the graph using the graph neural network to update the current edge embedding of each edge in the graph comprises, for each world-space edge in the graph: processing an input comprising: (i) the current edge embedding for the world-space edge, and (ii) the respective current node embedding for each node connected by the world-space edge, using a world-space edge updating sub-network of the graph neural network to generate an updated edge embedding for the world-space edge.

In some implementations, processing the respective current node embedding for each node in the graph to generate the respective dynamics feature corresponding to each node in the graph comprises, for each graph node: processing the current node embedding for the graph node using a decoder sub-network of the graph neural network to generate the respective dynamics feature for the graph node, wherein the dynamics feature characterizes a rate of change of a mesh node feature of the mesh node corresponding to the graph node.

In some implementations, determining the state of the physical environment at the next time step based on: (i) the dynamics features corresponding to the nodes in the graph, and (ii) the state of the physical environment at the current time step, comprises, for each mesh node: determining a mesh node feature of the mesh node at the next time step based on: (i) the mesh node feature of the mesh node at the current time step, and (ii) the rate of change of the mesh node feature.

In some implementations, the method further includes for one or more of the plurality of time steps: determining a respective set of one or more re-meshing parameters for each mesh node of the mesh; and adapting a resolution of the mesh based on the re-meshing parameters, comprising: splitting one or more edges in the mesh, collapsing one or more edges in the mesh, or both.

In some implementations, determining a respective set of one or more re-meshing parameters for each mesh node of the mesh comprises: after the updating, processing the respective current node embedding for each graph node using a re-meshing neural network to generate the respective re-meshing parameters for the mesh node corresponding to the graph node.

In some implementations, adapting the resolution of the mesh based on the re-meshing parameters comprises identifying, based on the re-meshing parameters, one or more mesh edges of the mesh that should be split, comprising, for one or more mesh edges: determining an oriented edge length of the mesh edge using the re-meshing parameters for a mesh node connected to the mesh edge; and in response to determining that the oriented edge length of the mesh edge exceeds a threshold, determining that the mesh edge should be split.

In some implementations, adapting the resolution of the mesh based on the re-meshing parameters comprises identifying, based on the re-meshing parameters, one or more mesh edges of the mesh that should be collapsed, comprising, for one or more mesh edges: determining, using the re-meshing parameters, an oriented edge length of a new mesh edge that would be created by collapsing the mesh edge; and in response to determining that the oriented edge length of the new mesh edge does not exceed a threshold, determining that the mesh edge should be collapsed.

In some implementations, when dependent upon claim 10, wherein the method is performed by data processing apparatus comprising one or more computers and including one or more hardware accelerator units; wherein updating the graph at each of one or more update iterations comprises updating the graph using a processor system comprising L message passing blocks, wherein each massage passing block has the same neural network architecture and a separate set of neural network parameters; the method further comprising: applying the message passing blocks sequentially to process the data defining the graph over multiple iterations; and using the one or more hardware accelerator units to apply the message passing blocks sequentially to process the data defining the graph.

In some implementations, the method is performed by data processing apparatus including multiple hardware accelerators, the method comprising distributing the processing using the message passing blocks over the hardware accelerators.

In some implementations, the physical environment comprises a real-world environment including a physical object; wherein obtaining the data defining the state of the physical environment at the current time step comprises obtaining, from the physical object, object data defining a 2D or 3D representation of a shape of the physical object; wherein inputting interaction data defining an interaction of the physical object with the real-world environment; wherein generating the representation of the state of the physical environment at the current time step uses the object data and the interaction data to generate the representation of the state of the physical environment; and wherein determining the state of the physical environment at the next time step comprises determining one or more of: i) updated object data defining an updated 2D or 3D representation of the shape of the physical object; ii) stress data defining a 2D or 3D representation of stress on the physical object; iii) data defining a velocity, momentum, density or pressure field in a fluid in which the object is embedded.

In some implementations, the interaction data comprises data representing a force or deformation applied to the object; generating the representation of the state of the physical environment at the current time step includes associating each mesh mode with a mesh node feature that defines whether or not the mesh node is part of the object; and determining the state of the physical environment at the next time step comprises determining updated object data defining an updated 2D or 3D representation of the shape of the physical object, or a representation of pressure or stress on the physical object.

In some implementations, the physical environment comprises a real-world environment including a physical object, wherein determining the state of the physical environment at the next time step comprises determining a representation of a shape of the physical object at one or more next time steps; and wherein the method further comprises comparing a shape or movement of the physical object in the real-world environment to the representation of the shape to verify the simulation.

According to a second aspect, there is provided a method of designing the shape of an object using the method of any preceding aspect, wherein the data defining the state of the physical environment at the current time comprises data representing a shape of an object; wherein determining the state of the physical environment at the next time step comprises determining a representation of the shape of the object at the next time step; and wherein the method of designing the object comprises backpropagating gradients of an objective function through the graph neural network to adjust the data representing the shape of the physical object to determine a shape of the object that optimizes the objective function.

In some implementations, the method further includes making a physical object with the shape that optimizes the objective function.

According to a third aspect, there is provided a method of controlling a robot using the method of any preceding aspect, wherein the physical environment comprises a real-world environment including a physical object; wherein determining the state of the physical environment at the next time step comprises determining a representation of a shape or configuration of the physical object; wherein determining the state of the physical environment at the next time step comprises determining a predicted representation of the shape or configuration of the physical object; and wherein the method further comprises controlling the robot using the predicted representation to manipulate the physical object towards a target location, shape or configuration of the physical object by controlling the robot to optimize an objective function dependent upon a difference between the predicted representation and the target location, shape or configuration of the physical object.

According to a fourth aspect, there is provided a method performed by one or more data processing apparatus for simulating a state of a physical environment, the method comprising, for each of a plurality of time steps: obtaining data defining the state of the physical environment at the current time step; generating a representation of the state of the physical environment at the current time step, the representation comprising data representing a graph comprising a plurality of nodes that are each associated with a respective current node embedding and a plurality of edges that are each associated with a respective current edge embedding; updating the graph at each of one or more update iterations, comprising, at each update iteration: processing data defining the graph using a graph neural network to update the current node embedding of each node in the graph and the current edge embedding of each edge in the graph; after the updating, processing the respective current node embedding for each node in the graph to generate a respective dynamics feature corresponding to each node in the graph; and determining the state of the physical environment at a next time step based on: (i) the dynamics features corresponding to the nodes in the graph, and (ii) the state of the physical environment at the current time step.

In some implementations, the data defining the state of the physical environment at current the time step comprises respective features of each of a plurality of particles in the physical environment at the current time step, and wherein each node in the graph representing the state of the physical environment at the current time step corresponds to a respective particle.

In some implementations, the plurality of particles comprise particles included in a fluid, a rigid solid, or a deformable material.

In some implementations, for each of the plurality of particles, the features of the particle at the current time step comprise a state of the particle at the current time step, wherein the state of the particle at the current time step comprises a position of the particle at the current time step.

In some implementations, for each of the plurality of particles, the state of the particle at the current time step further comprises a velocity of the particle at the current time step, an acceleration of the particle at the current time step, or both.

In some implementations, for each of the plurality of particles, the features of the particle at the current time step further comprise a respective state of the particle at each of one or more previous time steps.

In some implementations, for each of the plurality of particles, the features of the particle at the current time step further comprise material properties of the particle.

In some implementations, generating the representation of the state of the physical environment at the current time step comprises generating a respective current node embedding for each node in the graph, comprising, for each node in the graph: processing an input comprising one or more of the features of the particle corresponding to the node using a node embedding sub-network of the graph neural network to generate the current node embedding for the node.

In some implementations, for each node in the graph, the input to the node embedding sub-network further comprises one or more global features of the physical environment.

In some implementations, the global features of the physical environment comprise forces being applied to the physical environment, a gravitational constant of the physical environment, a magnetic field of the physical environment, or a combination thereof.

In some implementations, each edge in the graph connects a respective pair of nodes in the graph, and wherein generating the representation of the state of the physical environment at the current time step comprises: identifying each pair of particles in the physical environment that have respective positions which are separated by less than a threshold distance; and for each identified pair of particles, determining that the corresponding pair of nodes in the graph are connected by an edge.

In some implementations, the current edge embedding for each edge in the graph is a predefined embedding.

In some implementations, generating the representation of the state of the physical environment at the current time step comprises generating a respective current edge embedding for each edge in the graph, comprising, for each edge in the graph: processing an input comprising: respective positions of the particles corresponding to the nodes connected by the edge, a difference between the respective positions of the particles corresponding to the nodes connected by the edge, a magnitude of the difference between the respective positions of the particles corresponding to the nodes connected by the edge, or a combination thereof, using the an edge embedding sub-network of the graph neural network to generate the current edge embedding for the edge.

In some implementations, at each update iteration, processing data defining the graph using the graph neural network to update the current node embedding of each node in the graph comprises, for each node in the graph: processing an input comprising: (i) the current node embedding for the node, and (ii) the respective current edge embedding for each edge that is connected to the node, using a node updating sub-network of the graph neural network to generate an updated node embedding for the node.

In some implementations, at each update iteration, processing data defining the graph using the graph neural network to update the current edge embedding of each edge in the graph comprises, for each edge in the graph: processing an input comprising: (i) the current edge embedding for the edge, and (ii) the respective current node embedding for each node connected by the edge, using an edge updating sub-network of the graph neural network to generate an updated edge embedding for the edge.

In some implementations, processing the respective current node embedding for each node in the graph to generate the respective dynamics feature corresponding to each node in the graph comprises, for each node: processing the current node embedding for the node using a decoder sub-network of the graph neural network to generate the respective dynamics feature for the node, wherein the dynamics feature characterizes a rate of change in the position of the particle corresponding to the node.

In some implementations, the dynamics feature for each node comprises an acceleration of the particle corresponding to the node.

In some implementations, determining the state of the physical environment at the next time step based on: (i) the dynamics features corresponding to the nodes in the graph, and (ii) the state of the physical environment at the current time step, comprises: determining, for each particle, a respective position the particle at the next time step based on: (i) the position of the particle at the current time step, and (ii) the dynamics feature for the node corresponding to the particle.

In some implementations, the data defining the state of the physical environment at the current time step comprises data defining a mesh, wherein the mesh comprises a plurality of mesh nodes and a plurality of mesh edges, wherein each mesh node is associated with respective mesh node features, and wherein each node in the graph representing the state of the physical environment at the current time step corresponds to a respective mesh node.

In some implementations, the mesh spans the physical environment.

In some implementations, the mesh represents one or more objects in the physical environment.

In some implementations, for each of the plurality of mesh nodes, the mesh node features associated with the mesh node comprise a state of the mesh node at the current time step, wherein the state of the mesh node at the current time step comprises: positional coordinates representing a position of the mesh node in a frame of reference of the mesh at the current time step, positional coordinates representing a position of the mesh node in a frame of reference of the physical environment at the current time step, or both.

In some implementations, for each of the plurality of mesh nodes, the mesh node features associated with the mesh node at the current time step further comprise one or more of: a fluid density, a fluid viscosity, a pressure, or a tension, at a position in the environment corresponding to the mesh node at the current time step.

In some implementations, for each of the plurality of mesh nodes, the mesh node features associated with the mesh node further comprise a respective state of the mesh node at each of one or more previous time steps.

In some implementations, generating the representation of the state of the physical environment at the current time step comprises generating a respective current node embedding for each node in the graph, comprising, for each node in the graph: processing an input comprising one or more of the features of the mesh node corresponding to the node in the graph using a node embedding sub-network of the graph neural network to generate the current node embedding for the node in the graph.

In some implementations, for each node in the graph, the input to the node embedding sub-network further comprises one or more global features of the physical environment.

In some implementations, the global features of the physical environment comprise forces being applied to the physical environment, a gravitational constant of the physical environment, a magnetic field of the physical environment, or a combination thereof.

In some implementations, each edge in the graph connects a respective pair of nodes in the graph, wherein the graph comprises a plurality of mesh-space edges and a plurality of world-space edges, wherein generating the representation of the state of the physical environment at the current time step comprises: for each pair of mesh nodes that are connected by an edge in the mesh, determining that the corresponding pair of graph nodes are connected by a mesh-space edge in the graph; and for each pair of mesh nodes that have respective positions which are separated by less than a threshold distance in a frame of reference of the physical environment, determining that the corresponding pair of graph nodes are connected by a world-space edge in the graph.

In some implementations, generating the representation of the state of the physical environment at the current time step comprises generating a respective current edge embedding for each edge in the graph, comprising, for each mesh-space edge in the graph: processing an input comprising: respective positions of the mesh nodes corresponding to the graph nodes connected by the mesh-space edge in the graph, data characterizing a difference between the respective positions of the mesh nodes corresponding to the graph nodes connected by the mesh-space edge in the graph, or a combination thereof, using a mesh-space edge embedding sub-network of the graph neural network to generate the current edge embedding for the mesh-space edge.

In some implementations, the method further comprises for each world-space edge in the graph: processing an input comprising: respective positions of the mesh nodes corresponding to the graph nodes connected by the world-space edge in the graph, data characterizing a difference between the respective positions of the mesh nodes corresponding to the graph nodes connected by the world-space edge in the graph, or a combination thereof, using a world-space edge embedding sub-network of the graph neural network to generate the current edge embedding for the world-space edge.

In some implementations, at each update iteration, processing data defining the graph using the graph neural network to update the current node embedding of each node in the graph comprises, for each node in the graph: processing an input comprising: (i) the current node embedding for the node, and (ii) the respective current edge embedding for each edge that is connected to the node, using a node updating sub-network of the graph neural network to generate an updated node embedding for the node.

In some implementations, at each update iteration, processing data defining the graph using the graph neural network to update the current edge embedding of each edge in the graph comprises, for each mesh-space edge in the graph: processing an input comprising: (i) the current edge embedding for the mesh-space edge, and (ii) the respective current node embedding for each node connected by the mesh-space edge, using an mesh-space edge updating sub-network of the graph neural network to generate an updated edge embedding for the mesh-space edge.

In some implementations, at each update iteration, processing data defining the graph using the graph neural network to update the current edge embedding of each edge in the graph comprises, for each world-space edge in the graph: processing an input comprising: (i) the current edge embedding for the world-space edge, and (ii) the respective current node embedding for each node connected by the world-space edge, using a world-space edge updating sub-network of the graph neural network to generate an updated edge embedding for the world-space edge.

In some implementations, processing the respective current node embedding for each node in the graph to generate the respective dynamics feature corresponding to each node in the graph comprises, for each graph node: processing the current node embedding for the graph node using a decoder sub-network of the graph neural network to generate the respective dynamics feature for the graph node, wherein the dynamics feature characterizes a rate of change of a mesh node feature of the mesh node corresponding to the graph node.

In some implementations, determining the state of the physical environment at the next time step based on: (i) the dynamics features corresponding to the nodes in the graph, and (ii) the state of the physical environment at the current time step, comprises, for each mesh node: determining a mesh node feature of the mesh node at the next time step based on: (i) the mesh node feature of the mesh node at the current time step, and (ii) the rate of change of the mesh node feature.

In some implementations, the method further comprises for one or more of the plurality of time steps: determining a respective set of one or more re-meshing parameters for each mesh node of the mesh; and adapting a resolution of the mesh based on the re-meshing parameters, comprising: splitting one or more edges in the mesh, collapsing one or more edges in the mesh, or both.

In some implementations, determining a respective set of one or more re-meshing parameters for each mesh node of the mesh comprises: after the updating, processing the respective current node embedding for each graph node to generate the respective re-meshing parameters for the mesh node corresponding to the graph node.

In some implementations, adapting the resolution of the mesh based on the re-meshing parameters comprises identifying, based on the re-meshing parameters, one or more mesh edges of the mesh that should be split, comprising, for one or more mesh edges: determining an oriented edge length of the mesh edge using the re-meshing parameters for a mesh node connected to the mesh edge; and in response to determining that the oriented edge length of the mesh edge exceeds a threshold, determining that the mesh edge should be split.

In some implementations, adapting the resolution of the mesh based on the re-meshing parameters comprises identifying, based on the re-meshing parameters, one or more mesh edges of the mesh that should be collapsed, comprising, for one or more mesh edges: determining, using the re-meshing parameters, an oriented edge length of a new mesh edge that would be created by collapsing the mesh edge; and in response to determining that the oriented edge length of the new mesh edge does not exceed a threshold, determining that the mesh edge should be collapsed.

According to a fifth aspect, there are provided one or more non-transitory computer storage media storing instructions that when executed by one or more computers cause the one or more computers to perform the operations of the respective method of any preceding aspect.

According to a sixth aspect, there is provided a system including: one or more computers; and one or more storage devices communicatively coupled to the one or more computers, where the one or more storage devices store instructions that, when executed by the one or more computers, cause the one or more computers to perform the operations of the respective method of any preceding aspect.

The subject matter described in this specification can be implemented in particular embodiments so as to realize one or more of the following advantages.

Realistic simulators of complex physics are invaluable to many scientific and engineering disciplines. However conventional simulation systems can be very expensive to create and use. Building a conventional simulator can entail years of engineering effort, and often must trade off generality for accuracy in a narrow range of settings. Furthermore, high-quality simulators require substantial computational resources, which makes scaling up prohibitive. The simulation system described in this specification can generate simulations of complex physical environments over large numbers of time steps with greater accuracy and using fewer computational resources (e.g., memory and computing power) than some conventional simulation systems. In certain situations, the simulation system can generate simulations one or more orders of magnitude faster than conventional simulation systems. For example, the simulation system can predict the state of a physical environment at a next time step by a single pass through a neural network, while conventional simulation systems may be required to perform a separate optimization at each time step.

The simulation system generates simulations using a graph neural network that can learn to simulate complex physics directly from training data, and can generalize implicitly learned physics principles to accurately simulate a broader range of physical environments under different conditions than are directly represented in the training data. This also allows the system to generalize to larger and more complex settings than those used in training. In contrast, some conventional simulation systems require physics principles to be explicitly programmed, and must be manually adapted for the specific characteristics of each environment being simulated.

The simulation system can perform mesh-based simulations, e.g., where the state of the physical environment at each time step is represented by a mesh. Performing mesh-based simulations can enable the simulation system to simulate certain physical environments more accurately than would otherwise be possible, e.g., physical environments that include deforming surfaces or volumes that are challenging to model as a cloud of disconnected particles. Performing mesh-based simulations can also enable the simulation system to dynamically adapt the resolution of the mesh over the course of the simulation, e.g., to increase the resolution of the mesh at parts of the simulation where more accuracy is required, thereby increasing the overall accuracy of the simulation. By dynamically adapting the resolution of the mesh, the simulation system is able to generate a simulation of a given accuracy using fewer computational resources, when compared to some conventional simulation systems.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example physical environment simulation system.

FIG. 2 illustrates example operations of a physical environment simulation system.

FIG. 3 illustrates example simulation of a physical environment.

FIG. 4 is a flow diagram of an example process for simulating a physical environment.

FIG. 5A illustrates an example regular mesh and an example adaptive mesh.

FIG. 5B illustrates an example world space edge and an example mesh space edge.

FIG. 6A illustrates an example of an adaptive remeshing simulation compared to ground truth and to a grid-based simulation.

FIG. 6B illustrates an example of a generalized simulation generated by a physical environment simulation system.

FIG. 7 illustrates example operations used in adaptive remeshing.

FIG. 8 illustrates an example simulation with adaptive remeshing.

FIG. 9 illustrates an example simulation generated by a physical environment simulation system, where the physical environment being simulated is represented by a collection of particles.

FIG. 10 illustrates example simulations generated by a physical environment simulation system for different types of materials.

Like reference numbers and designations in the various drawings indicate like elements.

### DETAILED DESCRIPTION

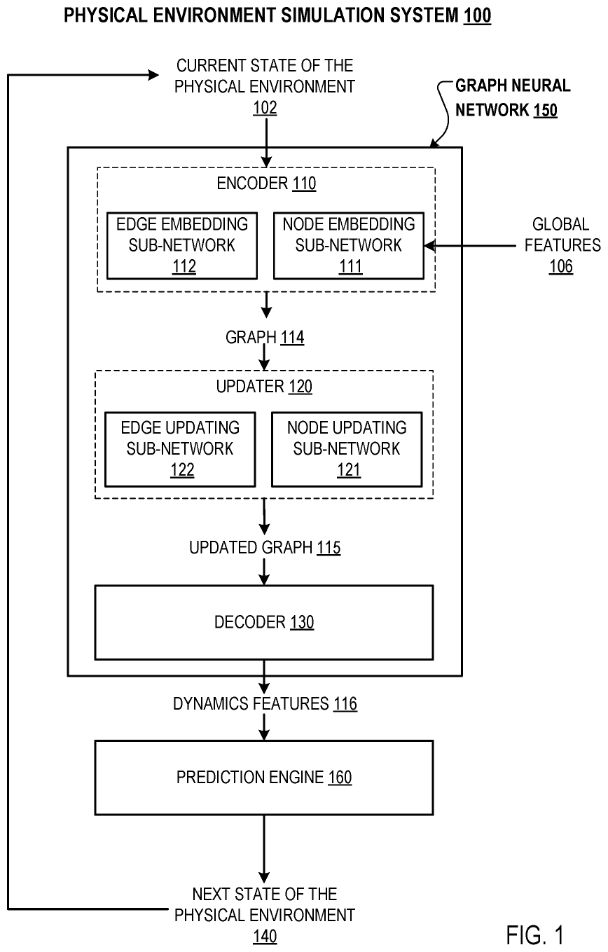

FIG. 1 is a block diagram of an example physical environment simulation system 100 that can simulate a state of a physical environment. The physical environment simulation system 100 is an example of a system implemented as computer programs on one or more computers in one or more locations in which the systems, components, and techniques described below are implemented.

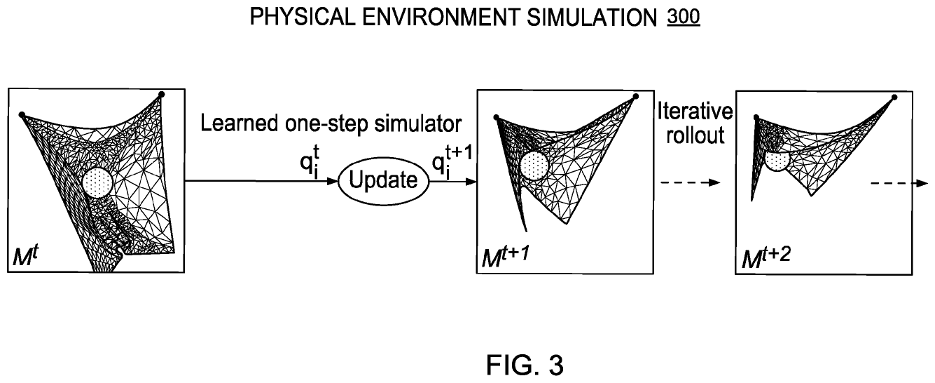

A “physical environment” generally refers to any type of physical system including, e.g., a fluid, a rigid solid, a deformable material, any other type of physical system or a combination thereof. A “simulation” of the physical environment can include a respective simulated state of the environment at each time step in a sequence of time steps. The state of the physical environment at a time step can be represented, e.g., by a collection of particles or a mesh, as will be described in more detail below. The state of the environment at the first time step can be provided as an input to the physical environment simulation system 100, e.g., by a user of the system 100. At each time step in a sequence of time steps, the system 100 can process the input and generate a prediction of the state of the physical environment at the next time step 140. An example simulation of a physical environment is shown in FIG. 3.

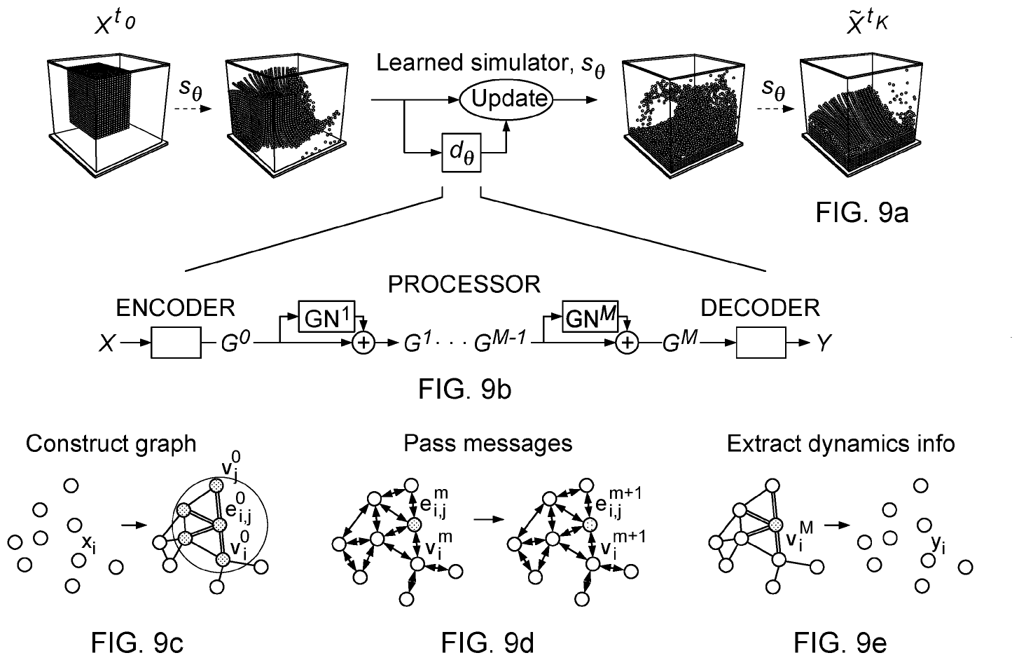

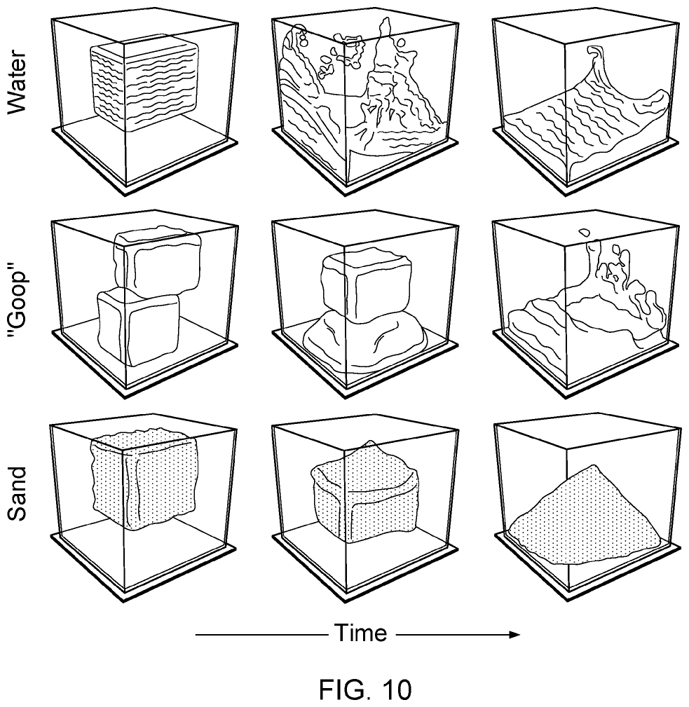

While some physical environments, such as those that include, e.g., fluids, can be effectively simulated as a set of individual particles (e.g., as shown in FIGS. 9 and 10), other physical environments such as those that include, e.g., deformable materials and complex structures, may be more challenging to simulate in the same manner. In particular, simulating such systems through particle representations may be computationally inefficient and prone to failure. Instead, such physical environments can be more appropriately represented by a mesh that can, e.g., span the whole of the physical environment, or represent respective surfaces of one or more objects in the environment (e.g., as shown in FIGS. 3, 6A, 6B, and 8).

The physical environment simulation system 100 can be used to simulate the dynamics of different physical environments through either particle-based representations or mesh-based representations. It should be understood that the example physical environments described below are provided for illustrative purposes only, and the simulation system 100 can be used to simulate the states of any type of physical environment including any type of material or physical object. Simulations of particle-based representations of the physical environment and simulations of mesh-based representations of the physical environment will be described in turn in the following.

The simulation system 100 can process a current state of the physical environment 102 at a current time step to predict the next state of the physical environment 140 at a next time step.

The current state of the physical environment 102 can be represented as a collection of individual particles, where each particle is associated with a set of particle features (e.g., as shown in FIG. 9). Particle features associated with a particle can be defined by, e.g., a vector that specifies a spatial location (e.g., spatial coordinates) of the particle and, optionally, various physical properties associated with that particle including, e.g., a mass, a velocity, an acceleration, etc., at the time step. More specifically, a current state X of a physical environment including N particles can be represented as X=(x₀, . . . , x_{N-1}), where xᵢ is a vector representation of the features of particle i. The features associated with a particle at a current time step can further specify particle features associated with the particle at one or more previous time steps, as will be described in more detail below. The number of particles N representing the physical environment can be, e.g., 100, 1000, 10000, 100000, or any other appropriate number of particles.

The set of features xᵢ of a particle i at a time t can be defined by a state vector that characterizes various physical properties of the particle, e.g., as xᵢ^{t}^{ₖ}=[pᵢ^{t}^{ₖ}, \dot{p}ᵢ^{t}^{_{k-C+1}}, . . . , \dot{p}ᵢ^{t}^{ₖ}, fᵢ], where pᵢ^{t}^{ₖ} is the position of the particle at time t, fᵢ defines features that represent static material properties corresponding to the particle (e.g., a value of 0 can represent sand, a value of 1 can represent water, etc.), \dot{p}ᵢ^{s} is the velocity of the particle at the time step s, and C is a predefined number that specifies the number of previous velocities \dot{p} (e.g., velocities of the particle at each of C previous time steps) included in the set of features. For example, if C=1, then the set of features xᵢ of particle i at the current time step includes a velocity corresponding to the previous time step, and if C=5, then the set of features xᵢ of particle i at the current time step includes velocities corresponding to each of 5 previous time steps. The constant C can be a predetermined hyper-parameter of the simulation system 100.

Generally, the simulation system 100 can model the dynamics of the physical environment by mapping the current state X=(x₀, . . . , x_{N-1}) of the physical environment at time t onto the next state of the physical environment at time t+1. The dynamics of particles can be influenced by global physical aspects of the environment, such as, e.g., forces being applied to the physical environment, a gravitational constant of the physical environment, a magnetic field in the physical environment, etc., as well as well as by inter-particle interactions such as, e.g., an exchange of energy and momentum between the particles.

The graph neural network 150 of the simulation system 100 can include an encoder module 110, an updater module 120, a decoder module 130.

The encoder 110 can include a node embedding sub-network 111 and an edge embedding sub-network 112. At each time step, the encoder 110 can be configured to process data defining the current state of the physical environment 102 (e.g., =(x₀, . . . , x_{N-1})) to generate a representation of the current state of the physical environment 102 that can include, e.g., a graph 114. A “graph” (e.g., G=(V, E)) refers to a data structure that includes a set of nodes V and edges E, such that each edge connects a respective pair of nodes. To generate the graph 114, at each time step, the encoder 110 can assign a node to each of the N particles included in the data defining the current state of the physical environment 102 and instantiate edges between pairs of nodes in the graph 114.

In order to determine which pairs of nodes in the graph 114 should be connected by an edge, at each time step, the encoder 110 can identify each pair of particles in the current state of the physical environment 102 that have respective positions (e.g., as defined by their respective spatial coordinates) which are separated by less than a threshold distance, and instantiate an edge between such pairs of particles. The search for neighboring nodes can be performed via any appropriate search algorithm, e.g., a kd-tree algorithm.

In addition to assigning nodes to each of the particles, and instantiating edges between pairs of nodes corresponding to the particles, at each time step, the encoder 110 can generate a respective node embedding for each node in the graph 114. To generate an embedding of a node in the graph 114, the node embedding sub-network 111 of the encoder 110 can process particle features associated with the particle represented by the node.

In addition to the data representing the current state of the physical environment 102, the input into the node embedding sub-network 111 can also include global features 106 of the physical environment, e.g., forces being applied to the physical environment, a gravitational constant of the physical environment, a magnetic field of the physical environment, or any other appropriate feature or a combination thereof. Specifically, at each time step, the global features 106 can be concatenated onto the node features associated with each node in the graph 114, before the node embedding sub-network 111 processes the node features to generate an embedding for the node. (The node features associated with a node in the graph refer to the particle features associated with the particle represented by the node).

At each time step, the encoder 110 can also generate an edge embedding for each edge in the graph 114. Generally, an edge embedding for an edge connecting a pair of nodes in the graph 114 can represent pairwise properties of the corresponding particles represented by the pair of nodes. At each time step, for each edge in the graph 114, the edge embedding sub-network 112 of the encoder 110 can process features associated with the pair of nodes in the graph 114 connected by the edge, and generate a respective current edge embedding of the edge. Specifically, the edge embedding sub-network 112 can generate an embedding for each edge connecting a pair of nodes in the graph 114 based on e.g., respective positions of the particles corresponding to the nodes connected by the edge at the time step, a difference between the respective positions of the particles corresponding to the nodes connected by the edge at the time step, a magnitude of the difference between the respective positions of the particles corresponding to the nodes connected by the edge at the time step, or a combination thereof.

In some implementations, instead of determining the pairwise properties of particles and generating an embedding on that basis, the current edge embeddings for each edge in the graph 114 can be predetermined. For example, the edge embedding for each edge can be set to a trainable fixed bias vector, e.g., a fixed vector whose components are parameters of the simulation system 100 and are trained during training of the system 100.

After generating the graph 114 that represents the current state of the physical environment 102 at the time step, the simulation system 100 provides data defining the graph 114 to the updater 120, which updates the graph 114 over a number of internal update iterations to generate an updated graph 115 for the time step. “Updating” a graph refers to, at each update iteration, performing a step of message-passing (e.g., a step of propagation of information) between the nodes and edges included in the graph by, e.g., updating the node and/or edge embeddings for some or all nodes and edges in the graph based on node and/or edge embeddings of neighboring nodes in the graph. In other words, at each update iteration, the updater 120 maps an input graph, e.g., G^{t}=(V, E), onto an output graph G^{t+1}=(V, E), where the output graph may have the same structure as the input graph (e.g., the same nodes V and edges E) but different node and edge embeddings. In this way, at each update iteration, the simulation system 100 can simulate inter-particle interactions, e.g., the influence of a particle on its neighboring particles. The number of internal update interactions can be, e.g., 1, 10, 100, or any other appropriate number, and can be a predetermined hyper-parameter of the simulation system 100.

More specifically, the updater 120 can include a node updating sub-network 121 and an edge updating sub-network 122. At each update iteration, the node updating sub-network 121 can process the current node embedding for a node included in the graph 114, and the respective current edge embedding for each edge that is connected to the node in the graph 114, to generate an updated node embedding for the node. Further, at each update iteration, the edge updating sub-network 122 can process the current edge embedding for the edge and the respective current node embedding for each node connected by the edge to generate an updated edge embedding for the edge. For example, the updated edge embedding e_{i,j}′ of an edge connecting node i to node j, and the updated node embedding vᵢ′ of node i, can be represented as:

e′_{i,j}∂f^{e}(e_{i,j},vᵢ,vⱼ) v′ᵢ←f^{v}(vᵢ,Σⱼe′_{i,j}) (1)

where f^{e} and f^{v} represent the operations performed by the edge updating sub-network 122 and the node updating sub-network 121, respectively.

The final update iteration of the updater 120 generates data defining the final updated graph 115 for the time step. Data defining the updated graph 115 can be provided to the decoder 130 of the simulation system 100. The decoder 130 is a neural network that is configured to process a node embedding associated with a node in a graph to generate one or more dynamics features 116 for the node. At each time step, the decoder 130 can be configured to process a respective node embedding for each node in the updated graph 115 (e.g., updated node embeddings) to generate a respective dynamics feature 116 corresponding to each node in the updated graph 115, e.g., a feature that characterizes a rate of change in the position of the particle corresponding to the node.

In one example, the dynamics feature 116 for a node can include, e.g., an acceleration of the particle corresponding to the node. In another example, the dynamics feature 116 for a node can include, e.g., a velocity of the particle corresponding to the node. The node and edge embedding sub-networks (111, 112), the node and edge updating sub-networks (121, 122), and the decoder 130 can have any appropriate neural network architectures that enables them to perform their described function. For example, they can have any appropriate neural network layers (e.g., convolutional layers, fully connected layers, recurrent layers, attention layers, etc.) in any appropriate numbers (e.g., 2 layers, 5 layers, or 10 layers) and connected in any appropriate configuration (e.g., as a linear sequence of layers).

The system 100 can provide data defining the dynamics features 116 associated with nodes in the updated graph 115 to a prediction engine 160. The prediction engine 160 is configured to process dynamics features 116 associated with nodes in a graph to generate the next state of the physical environment 140. Specifically, at each time step, the prediction engine 160 can process data defining the dynamics features 116 corresponding to each node in the updated graph 114, and data defining the current state of the physical environment 102, to determine, for each particle represented by the node in the updated graph 115, a respective position of the particle at the next time step. The prediction engine 160 can also generate any other appropriate data including, e.g., a respective velocity of the particle at the next time step. Accordingly, at the current time step, the simulation system 100 can determine the next state of the physical environment 140.

For example, at each time step t, the decoder 130 can process data defining the updated graph 115 and generate a value of acceleration aᵢ^{t} for each particle i represented by a node in the updated graph 115. At each time step, the value of acceleration for each particle can be provided to the prediction engine 160 that can process it to predict a position of each particle at the next time step. Generally, the acceleration aᵢ^{t} for each particle can be defined as an average acceleration between the next step and the current step, e.g., as aᵢ^{t}=\dot{p}ᵢ^{t+1}−\dot{p}ᵢ^{t}, where \dot{p}ᵢ^{t} is the velocity of the particle at time t, and Δt is a constant and is omitted for clarity. Therefore, at each time step, based on the acceleration aᵢ^{t} of the particle i, the position of the particle i at a previous time step pᵢ^{t-1}, and the position of the particle at the current time step pᵢ^{t}, the position of the particle at the next time step (e.g., the next state of the physical environment 140) can be determined by the prediction engine 160 as follows:

pᵢ^{t+1}=aᵢ^{t}+2pᵢ^{t}−pᵢ^{t-1} (2)

Accordingly, at each time step, the simulation system 100 can process the current state of the physical environment 102 and generate the next state of the physical environment 140.

At each time step, the system 100 can provide the next state of the physical environment 140 as the current state of the physical environment 102 at the next time step. The system 100 can repeat this process over multiple time steps and thereby generate a trajectory of predicted states that simulate the states of the physical environment. The simulation can be used for any of a variety of purposes. In one example, a visual representation of the simulation may be generated, e.g., as a video, and provided to a user of the simulation system 100 (e.g., as illustrated in FIG. 10).

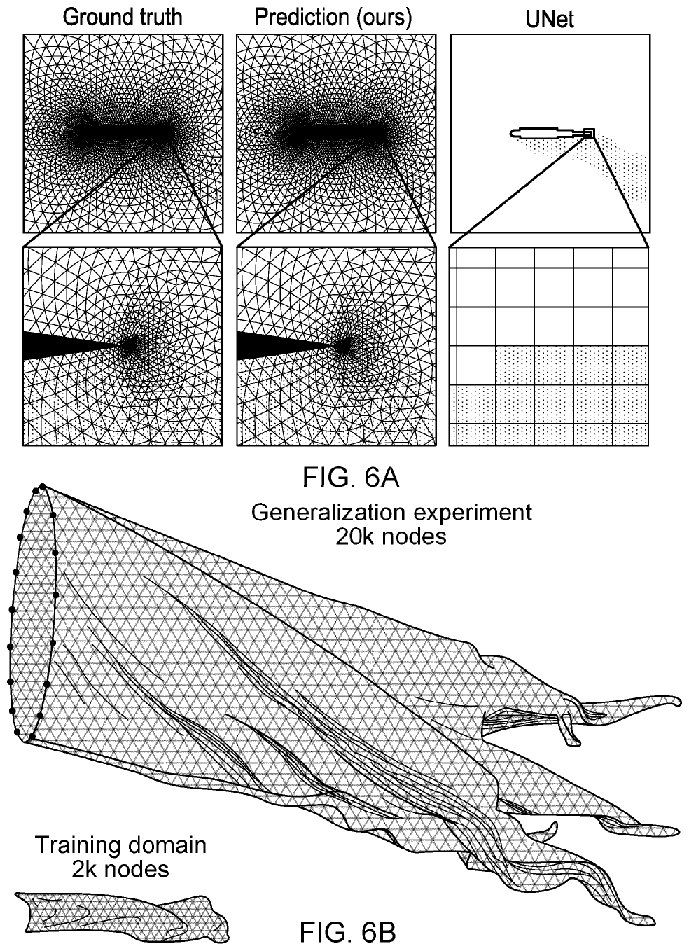

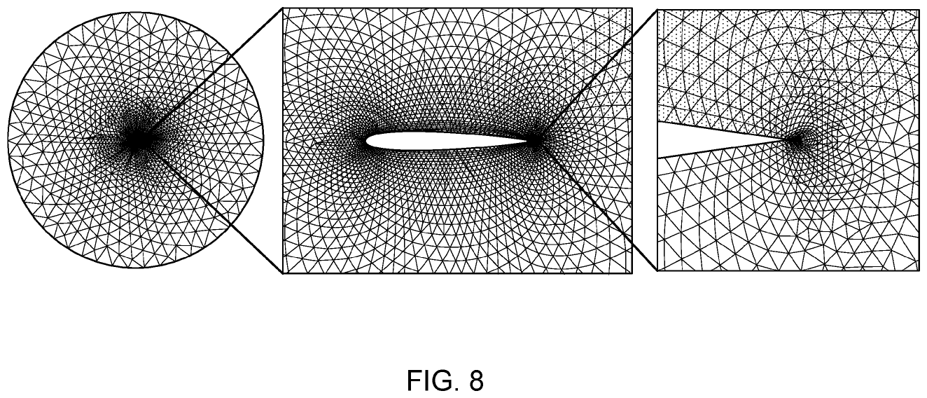

As described above, the simulation system 100 can be used to simulate physical environments represented as particles. However, some physical environments can more appropriately be represented as a mesh, e.g., a mesh that that spans the environment (e.g., as shown in FIG. 8), or a mesh that represents one or more objects the environment (e.g., as shown in FIGS. 3 and 6B). To simulate such systems, at each time step, the simulation system 100 can process data defining the current state of the physical environment 102, where such data specifies a mesh, generate a graph 114 based on the mesh, update the graph 114 over a number of update iterations to generate an updated graph 115, and predict the next state of the physical environment 140 based on the updated graph 115. Various aspects of this process will be described in more detail next.

Physical environments that include, e.g., continuous fields, deformable materials and/or complex structures, can be represented by a mesh M^{t}=(V, E^{M}). A “continuous field” generally refers to, e.g., a spatial region associated with a physical quality (e.g., velocity, pressure, etc.) that varies continuously across the region. For example, each spatial location in a velocity field can have a particular value of velocity associated with it.

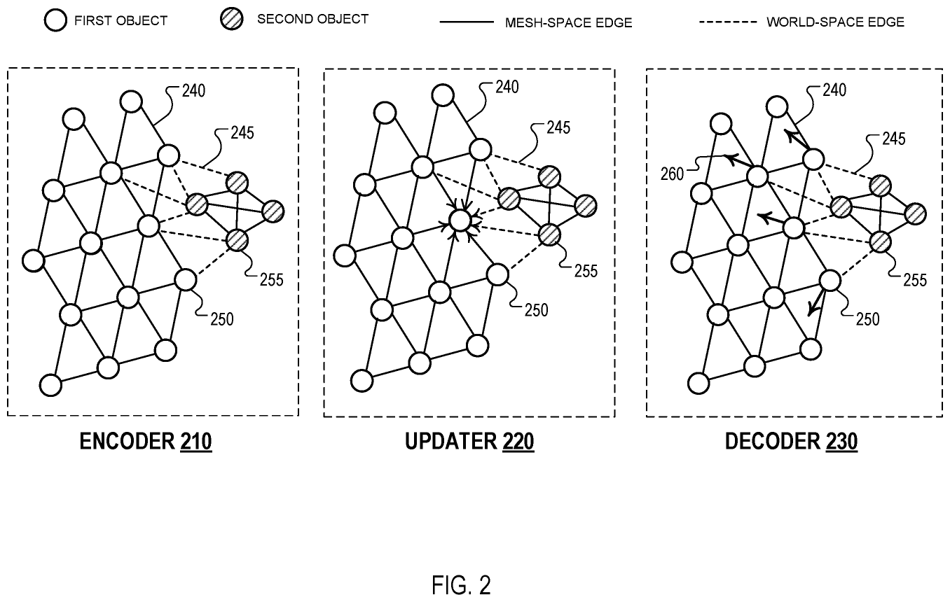

Generally, a “mesh” refers to a data structure that includes multiple mesh nodes V and mesh edges E^{M}, where each mesh edge E^{M} connects a pair of mesh nodes. The mesh can define an irregular (unstructured) grid that specifies a tessellation of a geometric domain (e.g., a surface, or space) into smaller elements (e.g., cells, or zones) having a particular shape, e.g., a triangular shape, or a tetrahedral shape. Each mesh node can be associated with a respective spatial location in the physical environment. In some implementations, the mesh can represent a respective surface of one or more objects in the environment. In some implementations, the mesh can span (e.g., cover) the physical environment, e.g., if the physical environment represents a continuous field, e.g., a velocity or pressure field. Examples of a mesh representation of a physical environment will be described in more detail below with reference to FIG. 2.

Similarly to particle-based representations described above, each mesh node in a mesh can be associated with current mesh node features that characterize a current state of the physical environment at a position in the environment corresponding to the mesh node. For example, in implementations that involve simulations of physical environments with continuous fields, such as, e.g., in a fluid dynamics or aerodynamics simulations, each mesh node can represent fluid viscosity, fluid density, or any other appropriate physical aspect, at a position in the environment that corresponds to the mesh node.

As another example, in implementations that involve simulations of physical environments with objects such as, e.g., structural mechanics simulations, each mesh node can represent a point on an object and can be associated with object-specific mesh node features that characterize the point on the object, e.g., the position of a respective point on the object, the pressure at the point, the tension at the point, and any other appropriate physical aspect. Furthermore, each mesh node can additionally be associated with mesh node features including one or more of: a fluid density, a fluid viscosity, a pressure, or a tension, at a position in the environment corresponding to the mesh node. Generally, mesh representations are not limited to the aforementioned physical systems and other types of physical systems can also be represented through a mesh and simulated using the simulation system 100.

In all implementations, and similarly to particle-based representations described above, the mesh node features associated with each mesh node can further include a respective state of the mesh node at each of one or more previous time steps.

As described above, the simulation system 100 can be used to process data defining the current state of the physical environment 102 (e.g., represented by a mesh e.g., M^{t}=(V, E^{M})) and generate data defining a prediction of the next state of the physical environment 140.

Specifically, at each time step, the encoder 110 can process the current state 102 to generate a graph 114 by assigning a graph node to each mesh node V included in the mesh M^{t}. Further, for each pair of mesh nodes V that are connected by a mesh edge, the encoder 110 can instantiate an edge, referred to as a mesh-space edge E^{M}, between the corresponding pair of nodes in the graph 114.

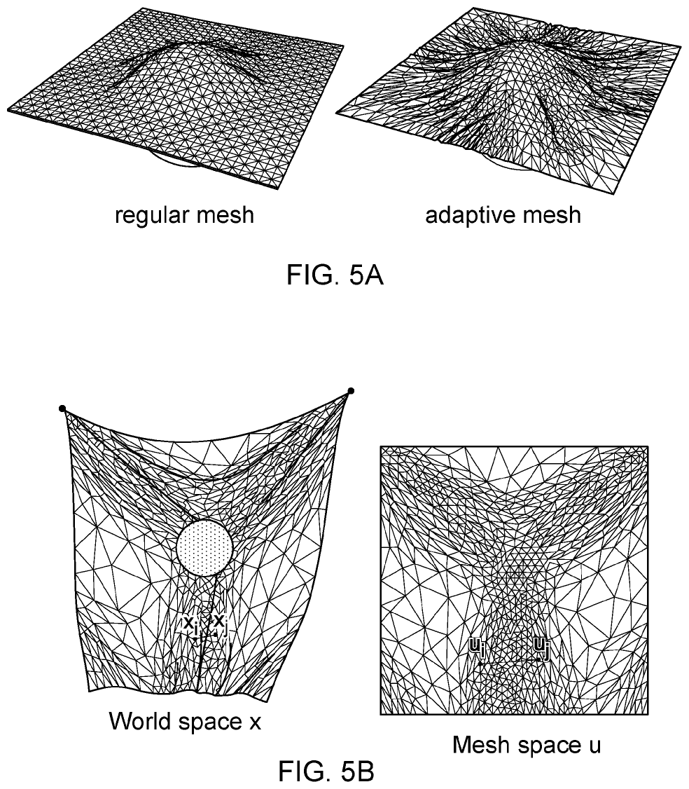

In implementations where the mesh represents one or more objects in the physical environment, the encoder 110 can process data defining the mesh and identify each pair of mesh nodes V in the mesh that have respective spatial positions which are separated by less than a threshold distance in world-space W (e.g., in the reference frame of the physical environment) and instantiate an edge, referred to as a world-space edge E^{W}, between each corresponding pair of nodes in the graph 114. In particular, the encoder 110 is configured to instantiate world-space edges between pairs of graph nodes that are not already connected by a mesh-space edge. Example world-space edges and mesh-space edges are illustrated in FIG. 5B.

In other words, the encoder 110 can transform a mesh M^{t}=(V, E^{M}) into a corresponding graph G=(V, E^{M}, E^{W}) that includes nodes V, and where some pairs of nodes are connected by mesh-space edges E^{M}, and some pairs of nodes are connected by world-space edges E^{W}. Representing the current state of the physical environment 102 through both mesh-space edges and world-space edges allows the system 100 to simulate interactions between a pair of mesh nodes that are substantially far removed from each other in mesh-space (e.g., that are separated by multiple other mesh nodes and mesh edges) but are substantially close to each other in world-space (e.g., that have proximate spatial locations in the reference frame of the physical environment), e.g., as illustrated with reference to FIG. 5B. In particular, including world-space edges in the graph allows more efficient message-passing between spatially-proximate graph nodes and thus allows more accurate simulation using fewer update iterations (i.e., message-passing steps) in the updater 120, thus reducing consumption of computational resources during simulation.

Similarly as for the particle-based representations described above, in addition to generating the graph 114, the encoder 110 of the system 100 can generate node and edge embeddings associated with the nodes and edges in the graph 114, respectively.

Specifically, at each time step, the node embedding sub-network 111 of the encoder 110 can process features associated with each node in the graph 114 (e.g., mesh node features), and generate a respective current node embedding for each node in the graph 114. In addition to the data representing the current state of the physical environment 102, the input into the node embedding sub-network 111 can also include global features 106 of the physical environment, e.g., forces being applied to the physical environment, a gravitational constant of the physical environment, a magnetic field of the physical environment, or any other appropriate feature or a combination thereof. At each time step, the global features 106 can be concatenated onto the node features associated with each node in the graph 114, before the node embedding sub-network 111 processes the node features to generate an embedding for the node.

At each time step, the graph neural network 150 can generate an edge embedding for each edge in the graph 114. For example, for each mesh-space edge E^{M} in the graph 114, a mesh-space edge embedding sub-network of the graph neural network 150 can process features associated with the pair of graph nodes that are connected by the mesh-space edge E^{M}, and generate a respective current edge embedding for the mesh-space edge. Specifically, the mesh-space edge embedding sub-network can generate an edge embedding for each mesh-space edge E^{M} in the graph 114 based on: respective positions of the mesh nodes corresponding to the graph nodes connected by the mesh-space edge in the graph, data characterizing a difference between the respective positions of the mesh nodes corresponding to the graph nodes connected by the mesh-space edge in the graph, or a combination thereof.

Similarly, at each time step, for each world-space edge E^{W} in the graph 114, a world-space edge embedding sub-network of the graph neural network can process features associated with the pair of graph nodes that are connected by the world-space edge E^{W}, and generate a respective current edge embedding for the world-space edge. Specifically, the world-space edge embedding sub-network can generate an edge embedding for each world-space edge E^{W} in the graph 114 based on: respective positions of the mesh nodes corresponding to the graph nodes connected by the world-space edge in the graph, data characterizing a difference between the respective positions of the mesh nodes corresponding to the graph nodes connected by the world-space edge in the graph, or a combination thereof.

Accordingly, at each time step, the encoder 110 can process the mesh and generate the graph 114 G=(V, E^{M}, E^{W}) with associated graph node embeddings, mesh-space edge embeddings and, in some implementations, also world-space edge embeddings.

After generating data defining the graph 114, at each time step, the simulation system 100 can provide the graph 114 to the updater 120 that can update the graph 114 over multiple internal update iterations to generate the final updated graph 115 for the time step. As described above, at each update iteration, the node updating sub-network 121 of the updater 120 can process an input that includes (i) the current node embedding for the node, and (ii) the respective current edge embedding for each edge that is connected to the node, to generate an updated node embedding for the node.

In implementations where the graph 114 includes mesh-space edges and world-space edges, the edge updating sub-network 122 of the updater 120 can include a mesh-space edge updating sub-network and a world-space edge updating sub-network. At each update iteration, the mesh-space edge updating sub-network can be configured to process an input that includes: (i) the current edge embedding for the mesh-space edge, and (ii) the respective current node embedding for each node connected by the mesh-space edge, to generate an updated edge embedding for the mesh-space edge. Further, at each update iteration, the world-space edge updating sub-network can be configured to process an input that includes: (i) the current edge embedding for the world-space edge, and (ii) the respective current node embedding for each node connected by the world-space edge, to generate an updated edge embedding for the world-space edge.

For example, the updated mesh-space edge embedding e_{i,j}^{M}′ of a mesh-space edge connecting node i to node j, the updated world-space edge embedding e_{i,j}^{W}′ of a world-space edge connecting node i to node j, and the updated node embedding vᵢ′ of node i, can be generated as:

e_{i,j}^{M}′←f^{M}(e_{i,j}^{M},vᵢ,vⱼ)e_{i,j}^{W}′←f^{W}(e_{i,j}^{W},vᵢ,vⱼ)vᵢ′←f^{v}(vᵢ,Σⱼe_{i,j}^{M}′,Σⱼe_{i,j}^{W}′) (3)

The mesh-space edge updating sub-network (f^{M}), the world-space edge updating subnetwork (f^{W}) and the node updating sub-network (f^{V}) can have any appropriate neural network architectures that enables them to perform their described function. For example, they can include any appropriate neural network layers (e.g., convolutional layers, fully connected layers, recurrent layers, attention layers, etc.) connected in any appropriate configuration (e.g., as a linear sequence of layers); merely as a particular example they may each be implemented using an MLP with a residual connection.

In some cases, each update of message passing can be implemented by a message passing block. Thus the graph neural network can be implemented as a set of L identical message passing blocks each with a separate set of network parameters. That is, the message passing blocks can be identical, i.e. have the same neural network architecture, but each can have a separate set of neural network parameters. Each message block can implement the mesh-space edge updating sub-network, the world-space edge updating subnetwork, and the node updating sub-network defined by Equation 3, i.e. a mesh-space edge updating sub-network to process and update a mesh-space edge embedding, a world-space edge updating subnetwork to process and update a world-space edge embedding, and a node updating sub-network to process and update a node embedding and the updated mesh-space and world-space edge embeddings. The message passing blocks can then be applied sequentially, i.e. each (except for the first which receives the current input graph) being applied to the output of the previous block to process the data defining the graph over multiple iterations.

The final update iteration of the updater 120 generates data representing the final updated graph 115 for the time step. At each time step, data defining the updated graph 115 can be provided to the decoder 130. The decoder 130 processes node embeddings associated with each node in the graph 115 and generates one or more dynamics features 116 for each node that characterize a rate of change of a mesh node feature of the mesh node corresponding to the graph node in the graph 115. The dynamics features 116 can represent a rate of change of any appropriate mesh node feature from the updated graph 115, e.g., position, velocity, momentum, density, or any other appropriate physical aspect.

At each time step, the prediction engine 160 can determine a mesh node feature at the next time step based on: (i) the mesh node feature of the mesh node at the current time step, and (ii) the rate of change of the mesh node feature by, e.g., integrating the rate of change of the mesh node feature any appropriate number of times. For example, for first-order systems, the prediction engine 160 can determine the position qᵢ^{t+1} of the mesh node i at the next time step based on the position qᵢ^{t} of the mesh node i at the current time step and the dynamics feature pᵢ corresponding to the mesh node i as:

qᵢ^{t+1}=pᵢ+qᵢ^{t} (4)

Similarly, for second-order systems, the prediction engine 160 can determine the position qᵢ^{t+1} of the mesh node i at the next time step based on the position qᵢ^{t} of the mesh node i at the current time step, the position qᵢ^{t-1} of the mesh node i at the previous time step, and the dynamics feature pᵢ corresponding to the mesh node i as:

qᵢ^{t+1}=pᵢ+2qᵢ^{t}−qᵢ^{t-1} (5)

Accordingly, by determining mesh node features for all mesh nodes at the next time step, the simulation system 100 can determine the next state of the physical environment 140.

A training engine can train the graph neural network 150 by using, e.g., supervised learning techniques on a set of training data. The training data can include a set of training examples, where each training example can specify: (i) a training input that can be processed by the graph neural network 150, and (ii) a target output that should be generated by the graph neural network 150 by processing the training input. The training data can be generated by, e.g., a ground-truth physics simulator (e.g., physics engine), or in any other appropriate manner e.g. from captured real-world data. For example, in particle-based implementations, the training input in each training example can include, for each particle in an environment, e.g., a vector xᵢ^{t} that specifies the features of particle i in the environment at time t. Optionally noise e.g. zero mean fixed variance random noise, can be added to the training input; this can improve the stability of rollouts during inference. The target output can include, for each particle in the environment, e.g., the acceleration aᵢ^{t} of particle i at time t.

At each training iteration, the training engine can sample a batch of one or more training examples from the training data and provide them to the graph neural network 150 that can process the training inputs specified in the training examples to generate corresponding outputs. The training engine can evaluate an objective function that measures a similarity between: (i) the target outputs specified by the training examples, and (ii) the outputs generated by the graph neural network, e.g., a cross-entropy or squared-error objective function. Specifically, the objective function L can be based on the predicted per-particle accelerations aᵢ^{t} as follows:

L(xᵢ^{t};θ)=∥d_{θ}(xᵢ^{t})−aᵢ^{t}∥² (6)

where d_{θ} is the graph neural network model and θ represents the parameter values of the graph neural network 150. The training engine can determine gradients of the objective function, e.g., using backpropagation techniques, and can update the parameter values of the graph neural network 150 using the gradients, e.g., using any appropriate gradient descent optimization algorithm, e.g., Adam. The training engine can determine a performance measure of the graph neural network on a set of validation data that is not used during training of the graph neural network 150. In mesh-based implementations, the training engine can train the graph neural network 150 in a similar way as described above, but the training inputs can include mesh node features, instead of particle features.

Furthermore, in mesh-based implementations, the training data can be generated by using, e.g., a ground-truth simulator that is specific to a particular type of physical environment. The graph neural network 150 can therefore be trained by using different types of training data, where each training data is generated by a different ground-truth simulator and is specific to a particular type of the physical environment.

After training of the graph neural network 150, the system 100 can be used to simulate the state of different types of physical environments. For example, from single time step predictions with sounds of particles (or mesh nodes) during training, the system 100 can effectively generalize to different types of physical environments, different initial conditions, thousands of time steps, and at least an order of magnitude more particles (or mesh nodes).

In some implementations, the simulation system 100 can adaptively adjust a resolution of a simulated mesh over the course of a simulation. A “resolution” of the mesh generally refers to the number of mesh nodes and/or mesh edges that are used to represent a region of the physical environment in the mesh. For one or more of multiple time steps, the system 100 can identify which regions of the mesh need a “higher” resolution (e.g., more nodes and/or edges) or “lower” resolution (e.g., less nodes and/or edges) and adapt the nodes and/or edges in the mesh to the desired resolution. By way of example, if the physical environment represented by the mesh includes a fluid, and a solid boundary that comes into contact with the fluid, then the system 100 can dynamically increase the resolution in the region of the mesh that represents the area around the wall boundaries where high gradients of the velocity field are expected. An example of adaptive resolution is illustrated in FIGS. 5A, 6A, and 8.

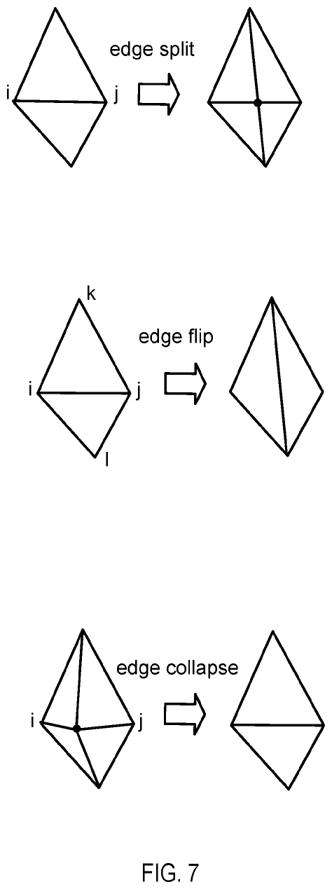

In one example, the system 100 can dynamically adjust the resolution of the mesh according to a sizing field methodology. More specifically, to dynamically adjust mesh resolution, the system 100 can iteratively apply three operations to the mesh: splitting one or more edges in the mesh, collapsing one or more edges in the mesh, and flipping one or more edges in the mesh. The operations are illustrated in FIG. 7.

“Splitting” a mesh edge that connects a first mesh node to a second mesh node can refer to replacing the mesh edge by (at least) two new mesh edges and a new mesh node. The first new mesh edge can connect the first mesh node to the new mesh node, and the second new mesh edge can connect the second mesh node to the new mesh node. When the mesh edge is split, a new node is created. The mesh node features of the new mesh node are determined by averaging the mesh node features of the first mesh node and the second mesh node. More specifically, the system 100 determines that a mesh edge uᵢⱼ connecting mesh node i to mesh node j should be split when:

uᵢⱼ^{T}Sᵢⱼuᵢⱼ>1 (7)

where Sᵢⱼ is an average sizing field tensor corresponding to nodes i and j, and is more specifically defined as:

Sᵢⱼ=½(Sᵢ+Sⱼ) (8)

In other words, when the system 100 determines that the condition defined in Equation 5 above is true for a mesh edge, then the system 100 determines that the mesh edge is invalid and should be split. The sizing field tensor S for a node can be a square matrix, e.g., a 2×2 matrix.

“Collapsing” a mesh edge that connects a first mesh node and a second mesh node can refer to removing the second mesh node, such that the first mesh node connects by a mesh edge to a different mesh node in the mesh, instead of the second mesh node. The system 100 can determine that a mesh edge should be collapsed if the collapsing operation does not create any new invalid mesh edges, e.g., mesh edges that satisfy the relationship defined in Equation 6.

“Flipping” a mesh edge that connects a pair of mesh nodes can refer to removing the mesh edge and instantiating a new mesh edge between a second, different, pair of mesh nodes in the mesh, where the second pair of mesh nodes are not initially connected by a mesh edge, and where the new mesh edge can be, e.g., substantially perpendicular in orientation to the original mesh edge. The system 100 can determine that a mesh edge should be flipped if the below criterion is satisfied:

(uⱼₖ×uᵢₖ)uᵢₗ^{T}S_{A}uⱼₗ<uⱼₖ^{T}S_{A}uᵢₖ(uᵢₗ×uⱼₗ) (9)

where S_{A} is an average sizing filed tensor corresponding to nodes i, j, k, and l.

As described above, the system 100 can iteratively perform the aforementioned operations in order to dynamically adjust the resolution of the mesh. For example, for one or more of multiple time steps, the system 100 can identify all possible mesh edges that satisfy the relationship defined in Equation 7 and split them. Next, the system 100 can identify all possible mesh edges that satisfy the relationship defined in Equation 9 and flip them. Next, the system 100 can identify all possible mesh edges that satisfy the relationship in Equation 7 and collapse them. Lastly, the system 100 can identify all possible mesh edges that satisfy Equation 9 and flip them. In this manner, the system 100 can dynamically adjust the resolution of the mesh to optimize the quality of simulation while consuming fewer computational sources than conventional simulation systems. Collectively, the operations can be referred to as being performed by a re-mesher R. The re-mesher R can be domain-independent, e.g., can be independent of the type of physical environment that is represented by the mesh to which the re-mesher is applied.

In some implementations, the system 100 can determine a respective set of one or more re-meshing parameters (e.g., including the sizing field tensor S) for each mesh node of the mesh, and adapt the resolution of the mesh based on the re-meshing parameters. At each time step, the system 100 can determine the re-meshing parameters for a mesh node in the mesh by processing the respective current node embedding for a graph node in the updated graph 115 (e.g., the graph generated by the final update iteration of the updater 120) using a neural network referred to as a re-meshing neural network, where the graph node corresponds to the mesh node. The re-meshing neural network can have any appropriate neural network architecture that enables it to perform its described function, e.g., processing a node embedding for a graph node to generate one or more re-meshing parameters for a corresponding mesh node in a mesh. In particular, the re-meshing neural network can include any appropriate neural network layers (e.g., fully-connected layers or convolutional layers) in any appropriate number (e.g., 2 layers, 5 layers, or 10 layers) and connected in any appropriate configuration (e.g., as a linear sequence of layers).

Accordingly, at each time step, the system 100 can generate data representing the next state of the physical environment 140 and additionally generate a set of re-meshing parameters for each mesh node in the mesh. Based on the re-meshing parameters, and by using the domain-independent re-mesher R, the system 100 can dynamically adjust the resolution of the mesh at the next time step. For example, the system 100 can determine the adapted mesh M′^{t+1} at the time step t+1 based on the original mesh M^{t+1} at the time step t+1 that has not been adapted, the re-meshing parameters S^{t+1} at the time step t+1, and the domain-independent re-mesher R as:

M′^{t+1}=R(M^{t+1},S^{t+1}) (11)

The system 100 can train the re-meshing neural network jointly with the graph neural network 150, e.g., using supervised learning techniques on a set of training data. The training data can be generated by, e.g., a domain-specific re-mesher that can generate a ground truth sizing field tensor for each mesh node in the mesh. The domain-specific re-mesher can generate a sizing field in accordance with domain-specific and manually defined rules. For example, for a simulation of a surface, a domain-specific re-mesher may be configured to generate re-meshing parameters to refine the mesh in areas of high curvature to ensure smooth bending dynamics. As another example, in a computational fluid dynamics simulation, a domain-specific re-mesher may be configured to generate re-meshing parameters to refine the mesh around wall boundaries where high gradients of the velocity field are expected. The system 100 can train the re-meshing neural network to optimize an objective function that measures an error (e.g., an L2 error) between: (i) re-meshing parameters generated for mesh nodes by the re-meshing neural network, and (ii) “target” re-meshing parameters generated by domain-specific re-meshers.

By training the re-meshing neural network on training data generated using the domain-specific re-meshers, the system enables the re-meshing neural network to implicitly learn the underlying re-meshing principles encoded in the domain-specific re-meshers and generalize them to new, previously unseen domains. Learned adaptive re-meshing can allow the system 100 to generate more accurate simulations using fewer computational resources, as described above. Generally, re-meshing parameters for a node can refer to any appropriate parameters that enable implementation of dynamic re-meshing. Sizing field tensors (as described above) are one example of re-meshing parameters. Other possible re-meshing parameters can be used as well, e.g., re-meshing parameters as described with reference to: Martin Wicke et al., “Dynamic local remeshing for elastoplastic simulation,” ACM Trans. Graph., 29(4), 2010.

After training, at each time step, the system 100 can process an input that includes a mesh that represents the current state of the physical environment and generate a set of re-meshing parameters for each mesh node in the mesh for the time step.

FIG. 2 illustrates operations performed by an encoder module, an updater module, and a decoder module of a physical environment simulation system (e.g., the system 100 in FIG. 1) on a graph representing a mesh. Specifically, the encoder 210 generates a representation of the current state of the physical environment (e.g., transforms a mesh into the graph), the updater 220 performs multiple steps of message passing (e.g., updates the graph), and decoder 230 extracts dynamics features corresponding to the nodes in the graph.

The graphs include a set of nodes, represented by circles (250, 255), and a set of edges, represented by lines (240, 245), where each edge connects two nodes. The graphs 200 may be considered simplified representations of the physical environment (an actual graph representing the environment may have far more nodes and edges than are depicted in FIG. 2).

In this illustration, the physical environment includes a first object and a second object, where the objects can interact with each other (e.g., collide). The first object is represented by nodes 250 that are depicted as a set of empty circles, and the second object is represented by nodes 255 that are depicted as a set of hatched circles 255. The nodes 250, corresponding to the first object, are connected by mesh-space edges 240 (E^{M}) that are depicted as solid lines. The nodes 255, corresponding to the second object, are also connected by mesh-space edges 240 (E^{M}). In addition to mesh-space edges, the graphs further include world-space edges 245 (E^{W}) that are depicted as dashed lines. The world-space edges 245 connect the nodes 250 representing the first object with the nodes 255 representing the second object. In particular, the world-space edges 245 can allow to simulate external dynamics such as, e.g., collisions, that are not captured by internal mesh-space interactions.

As described above, the encoder 210 generates a representation of the current state of the physical environment. In this illustration, the encoder 210 generates a graph that represents two objects and includes nodes, mesh-space edges, and world-space edges. The updater 220 performs message-passing between the nodes and edges in the graph. In particular, as described above, the updater 220 updates node embeddings and edge embeddings based on the node and edge embeddings of neighboring nodes and edges, respectively. For example, as shown in FIG. 2, a node embedding is updated based on the node embeddings of each of the neighboring nodes, and edge embeddings of all edges that connect the node to all neighboring nodes. After the last update iteration, the updater 220 generates an updated graph.

The decoder 230 processes the updated graph and extracts dynamics features 260 of each node in the graph. For example, in this illustration, the dynamics features 260 can be an acceleration corresponding to each mesh node represented by the nodes in the graph. The acceleration can be a result of, e.g., a collision of the first object with the second object. From the dynamics features, the simulation system 100 can determine the next state of the physical environment, e.g., the positions of mesh nodes that represent the first object and the second object.

FIG. 3 illustrates an example simulation of a physical environment 300 generated by a physical environment simulation system (e.g., the system 100 in FIG. 1). In this illustration, the physical environment is represented by a mesh. In particular, the operations of the encoder, the updater, and the decoder, used to generate the simulation 100, are illustrated above in FIG. 2 on a graph representation of the mesh.

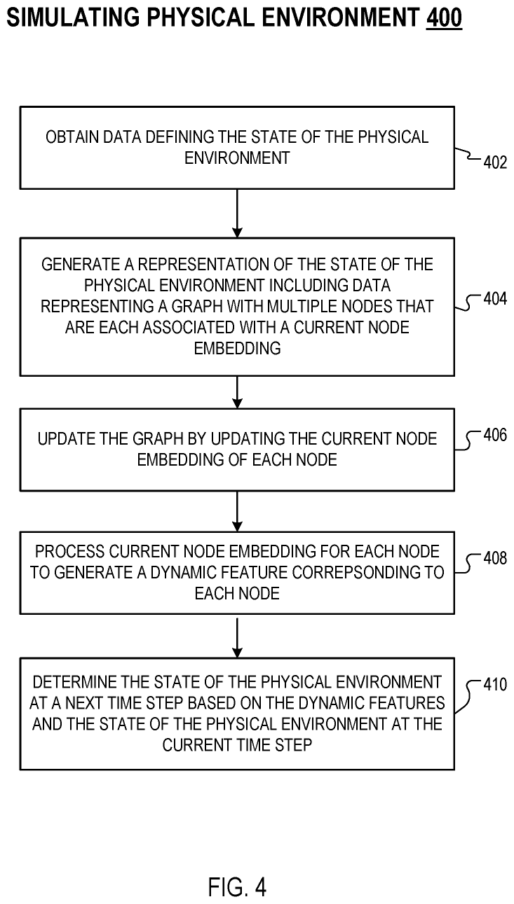

FIG. 4 is a flow diagram of an example process 400 for simulating a state of a physical environment. For convenience, the process 400 will be described as being performed by a system of one or more computers located in one or more locations. For example, a physical environment simulation system, e.g., the simulation system 100 of FIG. 1, appropriately programmed in accordance with this specification, can perform the process 400.

The system obtains data defining the state of the physical environment at the current time step (402). In some implementations, the data defining the state of the physical environment at the current time step includes respective features of each of multiple particles in the physical environment at the current time step. Each node in the graph, representing the state of the physical environment at the current time step, can correspond to a respective particle included in, e.g., a fluid, a rigid solid, or a deformable material. In some implementations, for each of multiple particles, the features of the particle at the current time step include a state (e.g., a position, a velocity, an acceleration, and/or material properties) of the particle at the current time step. The state of the particle at the current time step can further include a respective state of the particle at each of one or more previous time steps.

In some implementations, the data defining the state of the physical environment at the current time step further includes data defining a mesh including multiple mesh nodes and multiple mesh edges. In such implementations, each node in the graph representing the state of the physical environment at the current time step can correspond to a respective mesh node. The mesh can, e.g., span the physical environment and/or represent one or more objects in the physical environment. Each mesh node can be associated with respective mesh node features.

For example, for each mesh node, the mesh node features can include a state of the mesh node at the current time step, including, e.g., positional coordinates representing a position of the mesh node in a frame of reference of the mesh at the current time step, positional coordinates representing a position of the mesh node in a frame of reference of the physical environment at the current time step, or both. In another example, for each mesh node, the mesh node features can further include one or more of: a fluid density, a fluid viscosity, a pressure, or a tension, at a position in the environment corresponding to the mesh node at the current time step. In yet another example, the mesh node features associated with the mesh node can further include a respective state of the mesh node at each of one or more previous time steps.

The system generates a representation of the state of the physical environment at the current time step (404). The representation can be, e.g., data representing a graph including multiple nodes that are each associated with a respective current node embedding and multiple edges that are each associated with a respective current edge embedding. Each edge in the graph can connect a respective pair of nodes in the graph.

Generating the representation of the state of the physical environment at the current time step can include generating a respective current node embedding for each node in the graph. For example, the system can process an input including one or more of the features of the particle corresponding to the node using a node embedding sub-network of the graph neural network to generate the current node embedding for the node. In some implementations, the input into the node embedding sub-network further includes one or more global features of the physical environment, e.g., forces being applied to the physical environment, a gravitational constant of the physical environment, a magnetic field of the physical environment, or a combination thereof.

Generating the representation of the state of the physical environment at the current time step can further include identifying each pair of particles in the physical environment that have respective positions which are separated by less than a threshold distance, and for each identified pair of particles, determining that the corresponding pair of nodes in the graph are connected by an edge. The current edge embedding for each edge in the graph can be, e.g., a predefined embedding.

In some implementations, generating the representation of the state of the physical environment at the current time step can further include generating a respective current edge embedding for each edge in the graph. For example, for each edge in the graph, the system can process an input including: respective positions of the particles corresponding to the nodes connected by the edge, a difference between the respective positions of the particles corresponding to the nodes connected by the edge, a magnitude of the difference between the respective positions of the particles corresponding to the nodes connected by the edge, or a combination thereof, using an edge embedding sub-network of the graph neural network to generate the current edge embedding for the edge.

In implementations where data defining the state of the physical environment at the current time step further includes data defining a mesh, generating the representation of the state of the physical environment at the current time step, including generating a respective current node embedding for each node in the graph, can further include, for each node in the graph, processing an input including one or more of the features of the mesh node corresponding to the node in the graph using a node embedding sub-network of the graph neural network to generate the current node embedding for the node in the graph.

In such implementations, the graph can further include multiple mesh-space edges and multiple world-space edges. In such implementations, generating the representation of the state of the physical environment at the current time step includes, for each pair of mesh nodes that are connected by an edge in the mesh, determining that the corresponding pair of graph nodes are connected by a mesh-space edge in the graph, and for each pair of mesh nodes that have respective positions which are separated by less than a threshold distance in a frame of reference of the physical environment, determining that the corresponding pair of graph nodes are connected by a world-space edge in the graph. The system can generate a respective current edge embedding for each edge in the graph, including, for each mesh-space edge in the graph, processing an input comprising: respective positions of the mesh nodes corresponding to the graph nodes connected by the mesh-space edge in the graph, data characterizing a difference between the respective positions of the mesh nodes corresponding to the graph nodes connected by the mesh-space edge in the graph, or a combination thereof, using a mesh-space edge embedding sub-network of the graph neural network to generate the current edge embedding for the mesh-space edge.

The system can, for each world-space edge in the graph, process an input including: respective positions of the mesh nodes corresponding to the graph nodes connected by the world-space edge in the graph, data characterizing a difference between the respective positions of the mesh nodes corresponding to the graph nodes connected by the world-space edge in the graph, or a combination thereof, using a world-space edge embedding sub-network of the graph neural network to generate the current edge embedding for the world-space edge.

The system updates the graph at each of one or more update iterations (406). Updating the graph can include, at each update iteration, processing data defining the graph using a graph neural network to update the current node embedding of each node in the graph and the current edge embedding of each edge in the graph. For example, for each node in the graph, the system can process an input including: (i) the current node embedding for the node, and (ii) the respective current edge embedding for each edge that is connected to the node, using a node updating sub-network of the graph neural network, to generate an updated node embedding for the node. As another example, the system can process an input including: (i) the current edge embedding for the edge, and (ii) the respective current node embedding for each node connected by the edge, using an edge updating sub-network of the graph neural network, to generate an updated edge embedding for the edge.

In implementations that include a mesh, at each update iteration, processing data defining the graph using the graph neural network to update the current edge embedding of each edge in the graph can include, for each mesh-space edge in the graph, processing an input including: (i) the current edge embedding for the mesh-space edge, and (ii) the respective current node embedding for each node connected by the mesh-space edge, using an mesh-space edge updating sub-network of the graph neural network to generate an updated edge embedding for the mesh-space edge. Furthermore, for each world-space edge in the graph, the system can process an input including: (i) the current edge embedding for the world-space edge, and (ii) the respective current node embedding for each node connected by the world-space edge, using a world-space edge updating sub-network of the graph neural network to generate an updated edge embedding for the world-space edge.

After the updating, the system processes the respective current node embedding for each node in the graph to generate a respective dynamics feature corresponding to each node in the graph (408). For example, for each node, the system can process the current node embedding for the node using a decoder sub-network of the graph neural network to generate the respective dynamics feature for the node, where the dynamics feature characterizes a rate of change in the position (e.g., an acceleration) of the particle corresponding to the node.

In implementations that include a mesh, processing the respective current node embedding for each node in the graph to generate the respective dynamics feature corresponding to each node in the graph can include, for each graph node, processing the current node embedding for the graph node using a decoder sub-network of the graph neural network to generate the respective dynamics feature for the graph node, where the dynamics feature characterizes a rate of change of a mesh node feature of the mesh node corresponding to the graph node.

The system determines the state of the physical environment at a next time step based on: (i) the dynamics features corresponding to the nodes in the graph, and (ii) the state of the physical environment at the current time step (410). For example, for each particle, the system can determine a respective position of the particle at the next time step based on: (i) the position of the particle at the current time step, and (ii) the dynamics feature for the node corresponding to the particle.

In implementations that include a mesh, determining the state of the physical environment at the next time step based on: (i) the dynamics features corresponding to the nodes in the graph, and (ii) the state of the physical environment at the current time step, can include, for each mesh node, determining a mesh node feature of the mesh node at the next time step based on: (i) the mesh node feature of the mesh node at the current time step, and (ii) the rate of change of the mesh node feature.

Furthermore, in implementations that include a mesh, the system can, for one or more time steps, determine a respective set of one or more re-meshing parameters for each mesh node of the mesh, and adapt a resolution of the mesh based on the re-meshing parameters by, e.g., splitting one or more edges in the mesh, collapsing one or more edges in the mesh, or both. In such implementations, determining a respective set of one or more re-meshing parameters for each mesh node of the mesh can include, after the updating, processing the respective current node embedding for each graph node using a re-meshing neural network to generate the respective re-meshing parameters for the mesh node corresponding to the graph node.

In some implementations, the system can identify, based on the re-meshing parameters, one or more mesh edges of the mesh that should be split. This can include, for one or more mesh edges, determining an oriented edge length of the mesh edge using the re-meshing parameters for a mesh node connected to the mesh edge, and in response to determining that the oriented edge length of the mesh edge exceeds a threshold, determining that the mesh edge should be split. The system can also identify, based on the re-meshing parameters, one or more mesh edges of the mesh that should be collapsed. This can include, for one or more mesh edges, determining, using the re-meshing parameters, an oriented edge length of a new mesh edge that would be created by collapsing the mesh edge, and in response to determining that the oriented edge length of the new mesh edge does not exceed a threshold, determining that the mesh edge should be collapsed.

FIG. 5A illustrates example regular mesh and example adaptive mesh. The adaptive mesh can be generated by a physical environment simulation system (e.g., the system 100 in FIG. 1) as described above. The process of adaptive remeshing can enable significantly more accurate simulations than the regular mesh with the same number of mesh nodes.

FIG. 5B illustrates example world-space edges and mesh-space edges. In particular, two nodes that are positioned substantially far from each other in mesh-space can be positioned substantially close to each other in world-space, when compared to the mesh-space. Such nodes can be connected by a world-space edge.

FIG. 6A illustrates example adaptive remeshing simulation compared to ground truth and to grid-based simulation. Adaptive remeshing (e.g., as described above with reference to FIG. 5A) can generate a simulation that is substantially closer to ground truth than the grid-based simulation.

FIG. 6B illustrates an example generalized simulation generated by a physical environment simulation system (e.g., the system 100 in FIG. 1). The system is trained on a physical environment representation including approximately 2,000 mesh nodes. After training, the system can be scaled up to significantly larger and more complex environments, e.g., environments that are represented using 20,000 mesh nodes or more.

FIG. 7 illustrates example operations used in adaptive remeshing. The top illustrates an example splitting operation, the middle illustrates an example flipping operation, and the bottom illustrates an example collapsing operation.

FIG. 8 illustrates example aerodynamic simulation with adaptive remeshing. In particular, the representation of the wing tip (the right-hand panel) includes sub-millimeter details, while the entire simulation domain (left-hand panel) can still be appropriately represented by the mesh.

FIG. 9 illustrates example simulation generated by a physical environment simulation system, where the physical environment being simulated is represented by a collection of particles As described above with reference to FIG. 1, the simulation system can include an encoder module, an updater module (e.g., the processor in FIG. 9), and a decoder module. At each time step, the encoder module can process the current state of the physical environment (e.g., represented by a collection of particles) and generate a graph. At each time step, the updater module can update the graph over multiple internal update iterations to generate an updated graph. At each time step, the decoder can process the updated graph and extract dynamics features associated with each node in the updated graph. Based on the dynamics features, the system can determine the next state of the physical environment.

FIG. 10 illustrates example simulations generated by a physical environment simulation system for different types of materials. In this case, each of the environments are represented through a collection of particles. The materials include water, goop (i.e. a viscous, plastically deformable material), and sand.

One advantage of implementations of the above described systems and methods is that they can be configured for hardware acceleration. In such implementations, the method is performed by data processing apparatus comprising one or more computers and including one or more hardware accelerators units e.g. one or more GPUs (Graphics Processing Units) or TPUs (Tensor Processing Units). Such implementations involve updating the graph at each of one or more update iterations including updating the graph using a processor system comprising L message passing blocks, where each message passing block can have the same neural network architecture and a separate set of neural network parameters. The method can further include applying the message passing blocks sequentially to process the data defining the graph over multiple iterations, and using the one or more hardware accelerators to apply the message passing blocks sequentially to process the data defining the graph. In some implementations, the processing is performed using the message passing blocks, i.e. the processor system is distributed over the hardware accelerators. Thus there is provided a simulation method which is specifically adapted for implementation using hardware accelerators units, unlike some conventional approaches which are not capable of taking advantage of hardware acceleration.

The system can be used to predict physical quantities based on measured real-world data. Thus in some implementations of the above described systems and methods the physical environment comprises a real-world environment including a real, physical object. Then obtaining the data defining the state of the physical environment at the current time step may comprise obtaining, from the physical object, object data defining a 2D or 3D representation of a shape of the physical object. For example an image of the object may be captured by a camera such as a depth camera. The method may then involve inputting interaction data defining an interaction of the physical object with the real-world environment. For example the interaction data may define the shape of a second physical object, such as an actuator, which will interact with the physical object and may deform the physical object; or it may define a force applied to the physical object; or it may define a field such as a velocity, momentum, density or pressure field that the physical object is subjected to. Some more detailed examples are given below. The interaction data may, but need not be obtained from the real-world environment. For example it may be obtained from the real-world environment on one occasion but not on another occasion.

The method may then use the object data and the interaction data to generate the representation of the state of the physical environment at a current e.g. initial time step. The method may then determine the state of the physical environment at the next time step by determining one or more of: i) updated object data defining an updated 2D or 3D representation of the shape of the physical object; ii) stress data defining a 2D or 3D representation of stress on the physical object; and iii) data defining a velocity, momentum, density or pressure field in a fluid in which the object is embedded.

For example, in implementations the mesh node features may include a node type feature e.g. a one-hot vector indicating a type of the node, such as a mesh node feature that defines whether or not the mesh node is part of the object. The node type feature may indicate one or more types of boundary e.g. one or more of: whether the mesh node is part of the physical object or a boundary of the physical object; whether the mesh node is of another physical object, e.g. an actuator, or a boundary of the other physical object; whether the mesh node is a fluid node i.e. part of a fluid in which the physical object is embedded; whether the mesh node defines a boundary such as a wall, or obstacle, or inflow, or outflow boundary; whether the mesh node defines a fixed point, e.g. a fixed point of attachment of the object. Then using the object data to generate the representation of the state of the physical environment may involve assigning values to the mode type feature of each mesh node.

The interaction data may be used to assign values to the mesh nodes that do not define parts of the physical object e.g. to assign values to a velocity, momentum, density, or pressure field in a fluid in which the object is embedded, or to assign values to an initial position of the second physical object, or to an applied force. In the case of a second physical object such as an actuator, rather than being simulated, the dynamics features of the node may be updated to define motion of the second physical object, e.g. using next step world-space velocity xᵢ^{t+1}−xᵢ^{t} as an input.

Merely by way of example, if the physical object interacts with a force, actuator, or fluid flow the updated object data may define a representation of the shape of the physical object at a later time than the current (initial) time; and/or a representation of stress or pressure on the object; and/or a representation of the fluid flow resulting from an interaction with the physical object.

In some implementations of the above described systems and methods, as previously described, the physical environment comprises a real-world environment including a physical object, and determining the state of the physical environment at the next time step comprises determining a representation of a shape of the physical object at one or more next time steps. The method may then also involve comparing a shape or movement of the physical object in the real-world environment to the representation of the shape to verify the simulation. In some cases, e.g. where the shape evolves chaotically, the comparison may be made visually, to verify whether the simulation is accurate by estimating a visual similarity of the simulation to ground truth defined by the shape or movement of the physical object in the real-world environment. Also, or instead, such a comparison can be made by computing and comparing statistics representing the physical object in the real-world environment and the simulation.

The above described systems and methods are differentiable and may be used for design optimization. For example as previously described, the data defining the state of the physical environment at the current time may include data representing a shape of an object, and determining the state of the physical environment at the next time step may include determining a representation of the shape of the object at the next time step. A method of designing the shape of an object may then comprise comprises backpropagating gradients of an objective function through the (differentiable) graph neural network to adjust the data representing the shape of the physical object to determine a shape of the object that optimizes the objective function e.g. that minimizes a loss defined by the objective function. The objective function may be chosen according to one or more design criteria for the object, e.g. to minimize stress in the object the objective function may be a measure of stress in the object when subject to a force or deformation e.g. by including a representation of the force or deformation in the data defining the state of the physical environment. The process may include making a physical object with the designed shape i.e. with a shape that optimizes the objective function. The physical object may be e.g. for part of a mechanical structure.

The above described systems and methods may also be used for real-world control, in particular optimal control tasks, e.g. to assist a robot in manipulating a deformable object. Thus, as previously described, the physical environment may comprise a real-world environment including a physical object e.g. an object to be picked up or manipulated. Determining the state of the physical environment at the next time step includes determining a representation of a shape or configuration of the physical object e.g. by capturing an image of the object. Determining the state of the physical environment at the next time step may comprise determining a predicted representation of the shape or configuration of the physical object e.g. when subject to a force or deformation e.g. from an actuator of a robot. The method may further comprise controlling the robot using the predicted representation to manipulate the physical object, e.g. using the actuator, towards a target location, shape or configuration of the physical object by controlling the robot to optimize an objective function dependent upon a difference between the predicted representation and the target location, shape or configuration of the physical object. Controlling the robot may involve providing control signals to the robot based on the predicted representation to cause the robot to perform actions, e.g. using an actuator of the robot, to manipulate the physical object to perform a task. For example this may involve controlling the robot, e.g. the actuator, using a reinforcement learning process with a reward that is at least partly based on a value of the objective function, to learn to perform a task which involves manipulating the physical object.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A method performed by one or more data processing apparatus for simulating a state of a physical environment, the method comprising, for each of a plurality of time steps:
obtaining data defining the state of the physical environment at the current time step;
generating a representation of the state of the physical environment at the current time step, the representation comprising data representing a graph comprising a plurality of nodes that are each associated with a respective current node embedding and a plurality of edges that are each associated with a respective current edge embedding;
updating the graph at each of one or more update iterations, comprising, at each update iteration:
processing data defining the graph using a graph neural network to update the current node embedding of each node in the graph and the current edge embedding of each edge in the graph;
after the updating, processing the respective current node embedding for each node in the graph to generate a respective dynamics feature corresponding to each node in the graph; and
determining the state of the physical environment at a next time step based on: (i) the dynamics features corresponding to the nodes in the graph, and (ii) the state of the physical environment at the current time step.

33. The method of claim 32, wherein the data defining the state of the physical environment at current the time step comprises respective features of each of a plurality of particles in the physical environment at the current time step, and wherein each node in the graph representing the state of the physical environment at the current time step corresponds to a respective particle.

34. The method of claim 33, wherein the plurality of particles comprise particles included in a fluid, a rigid solid, or a deformable material.

35. The method of claim 33, wherein for each of the plurality of particles, the features of the particle at the current time step comprise a state of the particle at the current time step, wherein the state of the particle at the current time step comprises a position of the particle at the current time step.

36. The method of claim 35, wherein for each of the plurality of particles, the state of the particle at the current time step further comprises a velocity of the particle at the current time step, an acceleration of the particle at the current time step, or both.

37. The method of claim 35, wherein for each of the plurality of particles, the features of the particle at the current time step further comprise a respective state of the particle at each of one or more previous time steps.

38. The method of claim 35, wherein for each of the plurality of particles, the features of the particle at the current time step further comprise material properties of the particle.

39. The method of claim 33, wherein generating the representation of the state of the physical environment at the current time step comprises generating a respective current node embedding for each node in the graph, comprising, for each node in the graph:
processing an input comprising one or more of the features of the particle corresponding to the node using a node embedding sub-network of the graph neural network to generate the current node embedding for the node.

40. The method of claim 39, wherein for each node in the graph, the input to the node embedding sub-network further comprises one or more global features of the physical environment.

41. The method of claim 40, wherein the global features of the physical environment comprise forces being applied to the physical environment, a gravitational constant of the physical environment, a magnetic field of the physical environment, or a combination thereof.

42. The method of claim 33, wherein each edge in the graph connects a respective pair of nodes in the graph, and wherein generating the representation of the state of the physical environment at the current time step comprises:
identifying each pair of particles in the physical environment that have respective positions which are separated by less than a threshold distance; and
for each identified pair of particles, determining that the corresponding pair of nodes in the graph are connected by an edge.

43. The method of claim 33, wherein the current edge embedding for each edge in the graph is a predefined embedding.

44. The method of claim 33, wherein generating the representation of the state of the physical environment at the current time step comprises generating a respective current edge embedding for each edge in the graph, comprising, for each edge in the graph:
processing an input comprising: respective positions of the particles corresponding to the nodes connected by the edge, a difference between the respective positions of the particles corresponding to the nodes connected by the edge, a magnitude of the difference between the respective positions of the particles corresponding to the nodes connected by the edge, or a combination thereof, using the an edge embedding sub-network of the graph neural network to generate the current edge embedding for the edge.

45. The method of claim 33, wherein at each update iteration, processing data defining the graph using the graph neural network to update the current node embedding of each node in the graph comprises, for each node in the graph:
processing an input comprising: (i) the current node embedding for the node, and (ii) the respective current edge embedding for each edge that is connected to the node, using a node updating sub-network of the graph neural network to generate an updated node embedding for the node.

46. The method of claim 33, wherein at each update iteration, processing data defining the graph using the graph neural network to update the current edge embedding of each edge in the graph comprises, for each edge in the graph:
processing an input comprising: (i) the current edge embedding for the edge, and (ii) the respective current node embedding for each node connected by the edge, using an edge updating sub-network of the graph neural network to generate an updated edge embedding for the edge.

47. The method of claim 35, wherein processing the respective current node embedding for each node in the graph to generate the respective dynamics feature corresponding to each node in the graph comprises, for each node:
processing the current node embedding for the node using a decoder sub-network of the graph neural network to generate the respective dynamics feature for the node, wherein the dynamics feature characterizes a rate of change in the position of the particle corresponding to the node.

48. The method of claim 47, wherein the dynamics feature for each node comprises an acceleration of the particle corresponding to the node.

49. The method of claim 47, wherein determining the state of the physical environment at the next time step based on: (i) the dynamics features corresponding to the nodes in the graph, and (ii) the state of the physical environment at the current time step, comprises:
determining, for each particle, a respective position the particle at the next time step based on: (i) the position of the particle at the current time step, and (ii) the dynamics feature for the node corresponding to the particle.

50. A system comprising:
one or more computers; and
one or more storage devices communicatively coupled to the one or more computers, wherein the one or more storage devices store instructions that, when executed by the one or more computers, cause the one or more computers to perform operations comprising:
obtaining data defining the state of the physical environment at the current time step;
generating a representation of the state of the physical environment at the current time step, the representation comprising data representing a graph comprising a plurality of nodes that are each associated with a respective current node embedding and a plurality of edges that are each associated with a respective current edge embedding;
updating the graph at each of one or more update iterations, comprising, at each update iteration:
processing data defining the graph using a graph neural network to update the current node embedding of each node in the graph and the current edge embedding of each edge in the graph;
after the updating, processing the respective current node embedding for each node in the graph to generate a respective dynamics feature corresponding to each node in the graph; and
determining the state of the physical environment at a next time step based on: (i) the dynamics features corresponding to the nodes in the graph, and (ii) the state of the physical environment at the current time step.

51. One or more non-transitory computer storage media storing instructions that when executed by one or more computers cause the one or more computers to perform operations comprising:
obtaining data defining the state of the physical environment at the current time step;
generating a representation of the state of the physical environment at the current time step, the representation comprising data representing a graph comprising a plurality of nodes that are each associated with a respective current node embedding and a plurality of edges that are each associated with a respective current edge embedding;
updating the graph at each of one or more update iterations, comprising, at each update iteration:
processing data defining the graph using a graph neural network to update the current node embedding of each node in the graph and the current edge embedding of each edge in the graph;
after the updating, processing the respective current node embedding for each node in the graph to generate a respective dynamics feature corresponding to each node in the graph; and
determining the state of the physical environment at a next time step based on: (i) the dynamics features corresponding to the nodes in the graph, and (ii) the state of the physical environment at the current time step.
